(19) United States
(12) Patent Application Publication
(10) Pub. No.: US 2003/0052272 A1
(43) Pub. Date: Mar. 20, 2003

(54) Liquid concentration detecting method and apparatus

(76) Inventors: Norihiro Kiuchi, Tokyo (JP); Takehiro Kiuchi, Tokyo (JP)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(21) Appl. No.: 10/238,122

(22) Filed: Sep. 9, 2002

Related U.S. Application Data
(63) Continuation-in-part of application No. 09/953,643, filed on Sep. 17, 2001, now abandoned.

(30) Foreign Application Priority Data
Jan. 15, 2001 (WO) PCT/JP01/00200
Jan. 17, 2000 (JP) 2000-8406

(51) Int. Cl. G01N 21/35

(52) U.S. Cl. 250/339.12

(57) ABSTRACT

The present invention provides a liquid concentration detecting method and a liquid concentration detecting apparatus in which light beams of at least two different wavelength bands having a central wavelength within a range of from 1.4 to 2.05 μm are irradiated on to a solution, and concentrations of at least two constituents contained in the solution are detected by detecting the amount of light transmitting through the solution relative to the light beams of each wavelength band. The present invention permits inline real-time detection at a high accuracy of concentrations of a plurality of constituents contained in a chemical solution used in a semiconductor manufacturing process or a liquid crystal substrate manufacturing process. Further, according to the present invention, it is possible to high-accuracy and high-reliability detection of the liquid concentration with a simple configuration.

### CROSS-REFERENCE TO RELATED APPLICATION

This application is a continuation-in-part of co-pending application Ser. No. 09/953,643, filed Sep. 17, 2001, entitled “Liquid Concentration Detecting Method and Apparatus.”

### BACKGROUND OF THE INVENTION

The present invention generally relates to a concentration detecting technique of an aqueous solution containing various chemicals. More particularly, the invention relates to liquid concentration detecting method and apparatus which permit inline real-time detection at a high accuracy of concentration of constituents contained in a chemical solution such as a cleaning solution, an etching solution, or a resist stripping solution used in a semiconductor manufacturing process or a liquid crystal substrate manufacturing process, and permit inline real-time detection at a high accuracy of concentration of a plurality of constituents contained in such an aqueous solution.

In a semiconductor manufacturing process or a liquid crystal substrate manufacturing process, for example, for the purpose of cleaning an Si wafer, etching Al, Si or SiO₂, or stripping off a resist, various kind of acidic or alkaline aqueous solutions such as sulfuric acid (H₂SO₄), nitric acid (HNO₃), hydrochloric acid (HCl), phosphoric acid (H₃PO₄), hydrofluoric acid (HF), buffered hydrofluoric acid (BHF), fluoronitric acid, ammonium fluoride (NH₄F), ammonium hydroxide (NH₄OH), hydrogen peroxide (H₂O₂), RA-stripper, alkaline etching agents, chromic acid etching agents, and water/organic liquid mixture (for example, aqueous acetic acid solution) (hereinafter these aqueous solutions including a cleaning solution, an etching solution and resist stripping solution are generically referred to as “chemical solution(s)”).

In order to maintain performance of the etching solution, the cleaning solution or the resist stripping solution, it is necessary to measure concentration thereof for control purposes. In order to cope with the demand for a higher precision of etching, cleaning or resist stripping, furthermore, or to dispose of a waste water, it is required to measure and control varying concentration of the chemical solution in a real-time manner.

For the purpose of real-time measurement and control of concentration of chemical solutions as described above, it is very important to connect a concentration detecting apparatus of a chemical solution to, for example, an etching line, and continuously inline-measure the liquid concentration.

As is disclosed in Japanese Patent Application Laid-Open No. H07-113,745, the present inventor has proposed a concentration detecting apparatus for an aqueous solution containing an inorganic chemical such as hydrofluoric acid as a single constituent, suitable for the aforementioned object.

The present inventor has made another proposal of a liquid concentration detecting apparatus as disclosed in Japanese Patent Application Laid-Open No. H11-37,936. As shown in FIG. 18 of the present application, this apparatus is to detect liquid concentration by arranging a projecting section 207 and a receiving section 208 to face each other in a direction perpendicular to the axial line of a cell 201 made of a fluororesin to which the solution is fed, and sensing by the receiving section 208 the light of a particular wavelength from the projecting section 207, having passed through a liquid flowing in a detecting section 205. This invention particularly discloses high-accuracy measurement of liquid concentration by emitting a light beam having a wavelength within a range of from 1.3 to 1.9 μm, and detecting the amount of light received by the receiving section 208.

According to these techniques, it is possible to inline-measure in a real-time manner the concentration of a single constituent contained in a chemical solution.

However, as a cleaning solution or an etching solution, there may be used a multiple-constituent mixed chemical solution such as hydrofluoric acid-nitric acid (HF—HNO₃), hydrofluoric acid-hydrochloric acid (HF—HCl), sulfuric acid-hydrochloric acid (H₂SO₄—HCl) and phosphoric acid-nitric acid (H₃PO₄—HNO₃). It is, therefore, required to inline-measure the concentrations of individual constituents contained in mixed chemical solutions in a real-time manner, and to control the concentrations of individual constituents.

A concentration detecting apparatus permitting inline real-time measurement at a high accuracy the concentration of a plurality of constituents contained in such a multiple-constituent mixed chemical solution used as a cleaning solution or an etching solution has not as yet been proposed as far as the present inventor knows.

The above-mentioned Japanese Patent Application Laid-Open No. H11-37,936 discloses high-accuracy measurement of liquid concentration by use of absorption of a light beam having a wavelength within a particular range (1.3 to 1.9 μm) by the solution to be measured. It is required to control the concentration of an etching solution to ±0.1% in the case where the concentration of the etching solution is 0 to 10%, and to ±0.01% in the case where the concentration is 0 to 1% with a view to maintaining the etching solution or etching performance. As a result of a study of the present inventor, it is found that a further higher accuracy of measurement is required for this purpose.

The present invention has therefore an object to provide liquid concentration detecting method and apparatus which permit inline real-time detection at high accuracy of concentration of a plurality of constituents contained in aqueous solutions such as chemical solutions used in a semiconductor manufacturing process or a liquid crystal substrate manufacturing process, including a cleaning solution, an etching solution or a resist stripping solution.

Another object of the invention is to provide liquid concentration detecting method and apparatus which permit simplification of configuration, high-accuracy liquid concentration detection, and cost reduction.

Still another object of the invention is to provide liquid concentration detecting method and apparatus which permit detection at a further higher accuracy and with a high reliability, by a simple configuration, of the concentration of various inorganic chemicals contained in an aqueous chemical solution used in a semiconductor manufacturing process or a liquid substrate manufacturing process, such as a cleaning solution, an etching solution or a resist stripping solution, through deployment of the aforementioned conventional technique.

### BRIEF SUMMARY OF THE INVENTION

The present inventor carried out a near infrared spectroscopic analysis on hydrochloric acid and sulfuric acid with concentrations of 0, 2.5, 5, 7.5 and 10 wt. % as chemical solutions, and obtained the results as shown in FIGS. 10 and 11. It was confirmed that absorbance remarkably changed depending upon the liquid concentration with near a wavelength of 1.45 μm, near a wavelength range of from 1.55 to 1.9 μm, near a wavelength range of from 1.9 to 2.0 μm, and near a wavelength range of from 2.1 to 2.4 μm.

Further, the present inventor prepared aqueous solutions of hydrofluoric acid (HF) diluted to a concentration of 4 wt. % and 10 wt. %, respectively, to carry out a near infrared spectroscopic analysis, and obtained the result as shown in FIG. 9 of the present application. It was confirmed as a result that absorbance varied with the acid concentration at a wavelength within a range of from 1.3 to 2.0 μm, and particularly, that absorbance remarkably varied with the liquid concentration with a wavelength near 1.45 μm and near a range of wavelength of from 1.55 to 2.0 μm.

According to a study carried out by the present inventor, not limiting to a particular theory, absorption of light having a wavelength near 1.45 μm by an aqueous solution is considered to be due to an absorbing wavelength band belonging to an oxygen-hydrogen coupled group of water (overtone of O—H stretching vibration); the difference in light absorption at a wavelength near a range of from 1.55 to 1.9 μm is based on ionic hydration; and the difference in light absorption near a wavelength band within a range of from 1.9 to 2.0 μm is based on a sum (synthesis) of light absorption due to oxygen-hydrogen coupled group of water (synthesis of overtone of O-H stretching vibration and overtone of O—H bending vibration) and light absorption due to ionic hydration.

The near infrared absorbance spectra within near a wavelength range of from 1.4 to 2.0 μm is known to take the same shape as that of various aqueous solutions (chemical solutions), and the extent of light absorption (absorbance) depends upon the kind of chemical solution and the concentration thereof.

As a result of extensive studies carried out on the basis of the aforementioned findings, the present inventor developed novel method and apparatus which permit measurement of concentration of a chemical solution by use of light absorption in the near infrared region by an aqueous solution, and permit high-accuracy inline real-time measurement of the concentration of a plurality of constituents contained in a multiple-constituent mixed chemical solution. In summary, according to the first invention, there is provided a liquid concentration detecting method in which light beams of at least two different wavelength bands having a central wavelength within a range of from 1.4 to 2.05 μm are irradiated onto a solution, and concentrations of at least two constituents contained in the solution are detected by detecting the amount of light transmitting through the solution relative to the light beams of each wavelength band.

According to a preferred embodiment of the first invention, the light irradiated to the solution is selected from the light beams of at least two different wavelength bands having a central wavelength within a range of from 1.4 to 1.48 μm, from 1.55 to 1.85 μm, or from 1.9 to 2.05 μm.

According to an embodiment of the first invention, a first light having a central wavelength within a range of from 1.55 to 1.85 μm and a second light having a central wavelength within a range of from 1.42 to 1.48 μm (for example the first light having a central wavelength of 1.65±0.05 μm and the second light having a central wavelength of 1.45±0.015 μm) are irradiated onto the solution. According to another embodiment, a first light having a central wavelength within a range of from 1.9 to 2.05 μm and a second light having a central wavelength within a range from 1.42 to 1.48 μm (for example, the first light having a central wavelength of 2.0±0.05 μm and the second light having a central wavelength of 1.45±0.015 μm) are irradiated onto the solution. According to another embodiment, a first light having a central wavelength within a range of from 1.55 to 1.85 μm and a second light having a central wavelength within a range of from 1.9 to 2.05 μm (for example, the first light having a central wavelength of 1.65±0.05 μm and the second light having a central wavelength of 2.0±0.05 μm) are irradiated onto the solution. Further, according to another embodiment, a first light having a central wavelength within a range of from 1.55 to 1.85 μm, a second light having a central wavelength within a range of from 1.9 to 2.05 μm, and a third light having a central wavelength within a range of from 1.42 to 1.48 μm (for example the first light having a central wavelength of 1.65±0.05 μm, the second light having a central wavelength of 2.0±0.05 μm, and the third light having a central wavelength of 1.45±0.015 μm) are irradiated onto the solution.

According to the second invention, there is provided a liquid concentration detecting apparatus comprising a cell supplied with a solution; a means for irradiating light beams of at least two different wavelength bands having a central wavelength within a range of from 1.4 to 2.05 μm; a means for detecting the amount of light transmitted through the solution in said cell; wherein concentrations of at least two constituents contained in the solution based on the amount of light transmitting through the solution detected.

According to a preferred embodiment of the second invention, the liquid concentration detecting apparatus further comprises a means for taking out a part of the light irradiated onto the solution in the cell as a reference light, and correcting the amount of light transmitting through the solution in the cell on the basis of the amount of reference light.

According to an embodiment of the second invention, the liquid concentration detecting apparatus comprises (a) first and second projecting sections having respective light sources; (b) a beam splitter splitting the light emitted from the first and second projecting sections into a first direction and a second direction; (c) a transmitting light receiving section having a light detector receiving the light emitted from the first and second projecting sections, directed toward the first direction by the beam splitter, and transmitted through the solution in the cell; and (d) a reference light receiving section having a reference light detector receiving the light emitted from the first and second projecting sections, and directed toward the second direction by the beam splitter. According to another embodiment, the liquid concentration detecting apparatus comprises (a) first, second and third projecting sections having respective light sources; (b) a first beam splitter splitting the light emitted from the first and second projecting sections into a first direction and a second direction; (c) a second beam splitter splitting the light emitted from the third projecting section into a first direction and a second direction; (d) a first transmitting light receiving section having a light detector receiving the light emitted from the first and second projecting sections, directed toward the first direction by the first beam splitter, and transmitted through the solution in the cell; (e) a first reference light receiving section having a reference light detector receiving the light emitted from the first and second projecting sections, and directed toward the second direction by the first beam splitter; (f) a second transmitting light receiving section having a light detector receiving the light emitted from the third projecting section, directed toward the first direction by the second beam splitter, and transmitted through the solution in the cell; and (g) second reference light receiving section having a reference light detector receiving the light emitted from the third projecting section, and directed toward the second direction by the second beam splitter.

According to an embodiment of the second invention, optical axes of the light beams emitted from the first and second projecting section form right angles at the beam splitter.

According to another embodiment of the second invention, the liquid concentration detecting apparatus further comprises light cutoff means for cutting off the emitted light from at least any one of the first and second projecting sections to the beam splitter, wherein, in a state in which the light sources of the first and second projecting sections are simultaneously turned on, the light from one of the light sources is cut off at a prescribed timing. As the light cutoff means, one has a shutter mechanism may be used. In an embodiment, the light cutoff period by the light cutoff means may be within a range of from 1 to 10 seconds. The amount of transmission through the solution of the light emitted from any one of the first and second projecting sections may be detected by subtracting the amount of transmission through the solution of the light emitted from one of the projecting sections from the total amount of transmission through the solution of the light emitted from both of the first and second projecting sections.

According to an embodiment of the second invention, the light sources of each projecting section emit light beams of difference wavelength bands selected from the group consisting of light beams having a central wavelength within a range of from 1.42 to 1.48 μm, from 1.52 to 1.85 μm, and from 1.9 to 2.05 μm. The light sources of each projecting section may be selected from the group consisting of a laser diode emitting light having a central wavelength of 1.45±0.015 μm, a laser diode emitting light having a central wavelength of 1.65±0.05 μm, and a laser diode emitting light having a central wavelength of 2.0±0.05 μm.

According to another embodiment of the second invention, the liquid concentration detecting apparatus comprises (a) a projecting section having a variable wavelength type light source capable of emitting light beams of at least two different wavelength bands; (b) a beam splitter splitting the light emitted from the projecting section into a first direction and a second direction; (c) a transmitting light receiving section having a light detector receiving the light emitted from the projecting section, directed toward the first direction by the beam splitter, and transmitted through the solution in the cell; and (d) a reference light receiving section having a reference light detector receiving the light emitted from the projecting section, and directed toward the second direction by the beam splitter. As the variable wavelength type light source of the projecting section, one emits light beams of at least two different wavelength bands from among light beams having a central wavelength within a range of from 1.42 to 1.48 μm, from 1.55 to 1.85 μm, and from 1.9 to 2.05 μm may be used.

According to another embodiment of the second invention, the liquid concentration detecting apparatus further comprises a temperature control mechanism for all or part of the projecting section, the beam splitter, the transmitting light receiving section and the reference light receiving section. Further, according to another embodiment of the second invention, the liquid concentration detecting apparatus further comprises a temperature control mechanism for amplifying circuits of the out put of said light detector and said reference light detector. Preferably, the amplifying circuits of the output of said light detector and said reference light detector are formed integrally on the same substrate.

According to the third invention, there is provided a liquid concentration detecting apparatus comprising (a) a cell supplied with a liquid; (b) a first and second projecting sections having respective light sources; (c) a beam splitter for splitting the light emitted from the first and second projecting sections into a first direction and a second direction; (d) a transmitting light receiving section having a light detector receiving the light emitted from the first and second projecting sections, directed toward the first direction by the beam splitter, and transmitted through the solution in the cell; and (e) a reference light receiving section having a reference light detector receiving the light emitted from the first and second projecting sections, and directed toward the second direction by the beam splitter; wherein the optical axes of the light beams emitted from the first and second projecting sections cross each other at right angles in the beam splitter.

According to an embodiment of the third invention, the light sources of the first and second projecting sections emit light beams of different wavelength bands or of the same wavelength band.

According to another embodiment of the third invention, the liquid concentration detecting apparatus further comprises a temperature control mechanism for all or part of the projecting section, the beam splitter, the transmitting light receiving section and the reference light receiving section. Further, according to another embodiment of the third invention, the liquid concentration detecting apparatus further comprises a temperature control mechanism for amplifying circuits of the output of the light detector and the reference light detector. Preferably, the amplifying circuits of the output of the light detector and the reference light detector are formed integrally on the same substrates.

According to the fourth invention, there is provided a liquid concentration detecting apparatus comprising (a) a cell supplied with a solution; (b) a projecting section having a light source; (c) a beam splitter splitting the light beam from the projecting section into a first direction and a second direction; (d) a transmitting light receiving section having a light detector receiving the light emitted at the beam splitter to the first direction; and (e) a reference light receiving section having a reference light detector receiving the light emitted at the beam splitter to the second direction; wherein the apparatus further comprising a temperature control mechanism for all or part of the projecting section, the beam splitter, the transmitting light receiving section and the reference light receiving section.

According to an embodiment of the forth invention, the liquid concentration detecting apparatus further comprising a temperature control mechanism for amplifying circuits of output of said light detector and said reference light detector. Preferably, the amplifying circuits of the output of said light detector and said reference light detector are formed integrally on the same substrate.

In the second to fourth invention, according to an embodiment, the amount of light transmitting through the solution is detected by multiplying the ratio of the output from the light detector to the output of the reference light detector by a prescribed reference value to correct the output of the light detector.

In the second to forth invention, according to another embodiment, the beam splitter is a non-polarization beam splitter. As the beam splitter, a cube beam splitter may be used.

In the second to forth invention, according to another embodiment, the temperature control mechanism has a cooling mechanism based on Peltier device. Further, according to another embodiment, the temperature control mechanism further has a heat conducting member for transferring heat from an object of temperature control to the Peltier device. Preferably, at least the temperature control mechanism for the projecting section is independent of the temperature control mechanism for the other objects of temperature control.

In the aforementioned inventions, the solution comprises an etching solution, a cleaning solution, or a resist stripping solution. According to an embodiment, the solution contains two components selected from the group consisting of HF—H₂O₂, HF—HCl, HF—NH₄F, HF—HNO₃, NH₃—H₂O₂, H₂SO₄—H₂O₂, H₂SO₄-HCl, H₃PO₄—HNO₃, HCl—H₂O₂, KOH—H₂O₂, and HCl—FeCl₃, or three components selected from the group consisting of HF—HNO₃—CH₃COOH, and H₃PO₄—HNO₃—CH₃COOH.

### BRIEF DESCRIPTION OF THE SEVERAL VIEWS OF THE DRAWING

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a schematic configuration diagram of an embodiment of the optical system of the liquid concentration detecting apparatus of the present invention;

FIG. 2 is a schematic configuration diagram illustrating the detecting section and the control section of the liquid concentration detecting apparatus of the invention;

FIG. 3 is a schematic configuration diagram illustrating an embodiment of the cell used in the liquid concentration detecting apparatus of the invention;

FIGS. 4A and 4B are graphs showing examples of the sensitivity-temperature characteristics of the photo-diode;

FIG. 5 is a graph for explaining variation of the transmitting light PD output and the reference light PD output in cases with and without temperature control of the beam splitter;

FIG. 6 is a schematic configuration diagram of the detecting section illustrating an embodiment of the temperature control mechanism;

FIG. 7 is a schematic configuration diagram of the detecting section illustrating another embodiment of the temperature control mechanism;

FIG. 8 is a cross-sectional view of a heat conducting member;

FIG. 9 is a near infrared absorbance spectral diagram of hydrofluoric acid;

FIG. 10 is a near infrared absorbance spectral diagram of hydrochloric acid;

FIG. 11 is a near infrared absorbance spectral diagram of sulfuric acid;

FIG. 12 is a graph illustrating the relationship between the amount of light transmitting the solution (PD output) and the hydrochloric acid concentration;

FIG. 13 is a logarithmic graph illustrating the relationship between the amount of light transmitting the solution (PD output) and the hydrochloric acid concentration;

FIG. 14 is a graph illustrating the relationship between the amount of light transmitting the solution (PD output) and the concentration of the chemical solution for explaining an example of the concentration calculating technique according to the present invention;

FIG. 15 is a flowchart illustrating an embodiment of the calibrating procedure of concentration calculation formulae;

FIG. 16 is a flowchart illustrating an embodiment of the calibrating procedure of concentration calculation formulae, continued from the flowchart shown in FIG. 14;

FIG. 17 is a schematic configuration diagram illustrating the optical system component parts having a projecting section; and

FIG. 18 illustrates a conventional liquid concentration detecting apparatus.

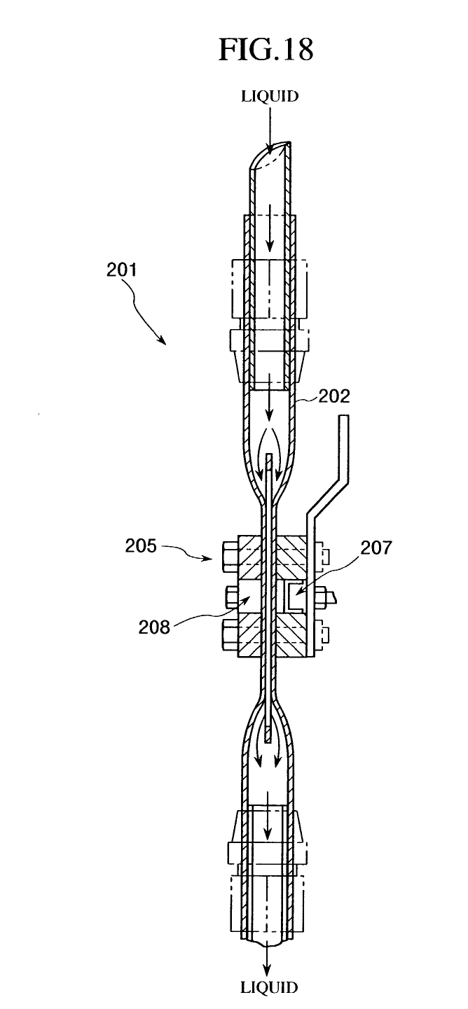

### DETAILED DESCRIPTION OF THE INVENTION

The liquid concentration detecting method and apparatus of the present invention will now be described in detail with reference to the drawings.

Embodiment 1

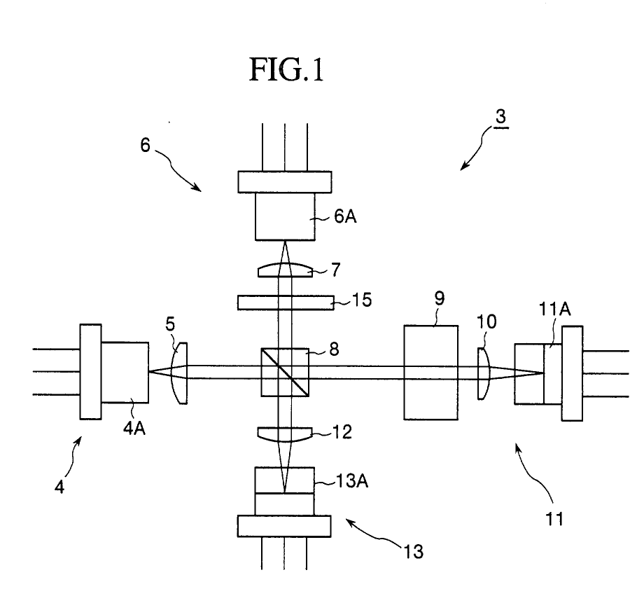

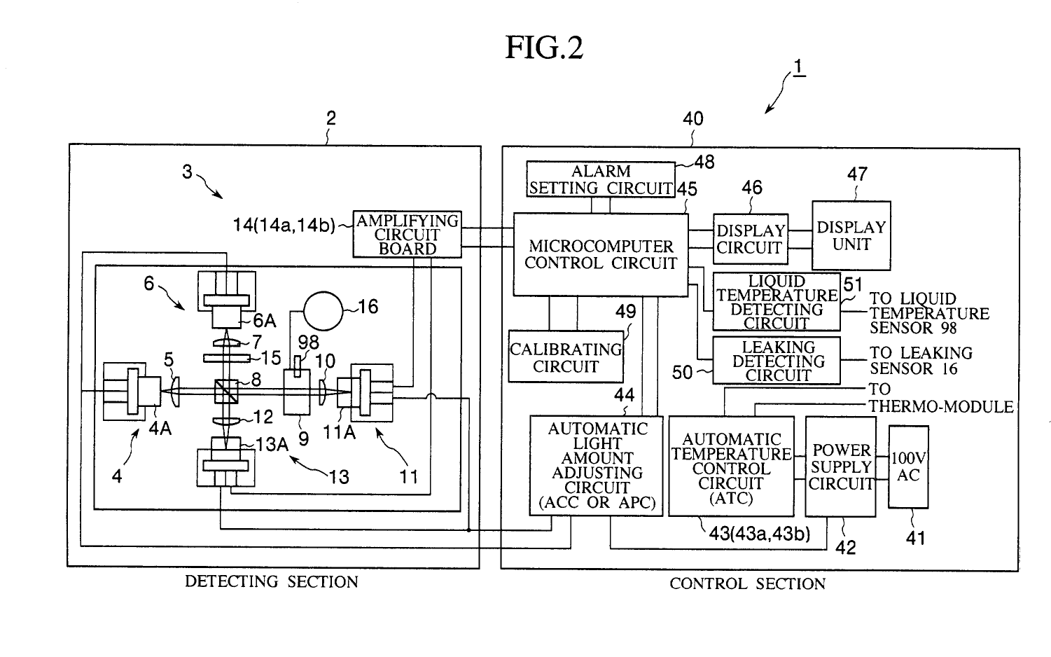

An embodiment of the liquid concentration detecting apparatus 1 of the invention will be described with reference to FIGS. 1 and 2. According to this embodiment, the liquid concentration detecting method of the invention is embodied in a liquid concentration detecting apparatus which, in a semiconductor manufacturing process or a liquid crystal substrate manufacturing process, is connected to an etching solution feeding source or a cleaning apparatus, and permits inline real-time detection of the concentration of a constituent contained in an etching solution or a cleaning solution.

The liquid concentration detecting apparatus 1 of this embodiment has a configuration permitting high-accuracy detection inline real-time detection at high accuracy of the concentrations of individual constituents contained in a binary-constituent chemical solution such as a hydrofluoric acid-nitric acid (HF—HNO₃) etching solution as a multiple-constituent chemical solution. As described later in detail, the liquid concentration detecting apparatus of this embodiment detects concentration, of individual constituents of a binary chemical solution by irradiating to the solution the light having two different wavelength bands of which the central wavelength is within a range of from 1.4 to 2.05 μm clearly exhibiting a difference in absorbance, depending upon the concentration of the solution or the quantity of water contained (water concentration). In this embodiment, the apparatus has a configuration in which light beams of two different wavelength bands are irradiated to the solution by providing a plurality of projecting sections each having a light source.

FIG. 1 is a schematic configuration diagram of an optical system 3 provided in a detecting section 2 of the liquid concentration detecting apparatus 1 of this embodiment; and FIG. 2 illustrates a schematic whole configuration including the detecting section 2 and a control section 40 of the liquid concentration detecting apparatus 1 of this embodiment.

In the optical system 3 provided in the detecting section 2 of the liquid concentration detecting apparatus 1, a first projecting section 4 and a transmitting light receiving section 11 are arranged in a direction perpendicular to the axial line of a liquid channel in a cell 9. The first projecting section 4 has a first light source 4A. The liquid concentration is detected by detecting the amount of the light emitted from the first light source 4A, transmitting through the liquid in the cell 9 and received by a light detector 11A of the transmitting light receiving section 11.

When detecting the liquid concentration at a high accuracy, light of a prescribed constant wavelength must be emitted from the light source at a constant intensity, and irradiated through the cell 9 into the light detector 11A. That is, it is important to control variations of the amount of light of the light source at high accuracy.

In the liquid concentration detecting apparatus 1 of this embodiment, as shown in FIG. 2, the first light source 4A is connected via an automatic light amount adjusting circuit 44 provided in the control section 40 to a power supply circuit 42, and power is supplied from a 100 V AC power supply 41. For example, an MPL-250 made by Wavelength Electronics Co. permitting constant current control (ACC) and constant light output control (APC) can be favorably used as an automatic light amount adjusting circuit 44.

Furthermore, variation of the amount of light of the light source is corrected at a higher accuracy by taking out, as reference light, a part of the light irradiated from the light source onto the sample chemical solution, and compensating the detected value of amount of light detected by the light detector 11A after transmitting through the sample chemical solution on the basis thereof.

More specifically, a beam splitter 8 is provided in the optical path running from the first light source 4A of the first projecting section 4 to the cell 9, and the light from the first light source 4A is irradiated via the beam splitter 8 onto the cell 9. A part of the light from the first light source 4A is taken out at the beam splitter 8, and sensed by a reference light receiving section 13 having a reference light detector 13A. In this embodiment, the reference light receiving section 13 is arranged in a direction perpendicular to an optical axis from the first projecting section 4 to the cell 9 and the transmitting light receiving section 11. The reference light reflected at right angles by the beam splitter 8 is sensed by the reference light detector 13A.

In this embodiment, a beam splitter 8 known as a half-mirror is used, which divides the incident light from the light source into two including a reflected light and a transmitting light at a ratio 1:1. In this embodiment, the beam splitter 8 is a non-polarization beam splitter having a cube shape (made by Sigma Koki Co.). The cube beam splitter is prepared by coating a metal (chromium) film or a dielectric multi-layer film to the slants of a 45° right-angle prisms made of quartz glass (BK7, class A), and bonding the slants. The cube beam splitter has further reflection preventing films on the light entering surface and the light leaving surface.

If a beam splitter other than a non-polarization one is used as the beam splitter 8, the split ratio of the reflected light to the transmitting light, i.e., the split ratio of the light entering the transmitting light receiving section 11 and that entering the reference light receiving section 13 largely vary with variation of the amount of light of the light source. It is therefore desirable to use a non-polarization beam splitter as the beam splitter 8. The cube-shaped beam splitter 8 is favorable because it permits easy temperature control as described later in detail.

A collimator lens 5 is provided in the first projecting section 4 for causing the light beam from the first light source 4A to enter the beam splitter 8 as parallel beams. The transmitting light receiving section 11 and the reference light receiving section 13 have respective condenser lenses 10 and 12 which condense the light beams directed toward respective directions by the beam splitter 8 to the light sensing portion of the light detector 11A and the reference light detector 13A, respectively.

The cell 9 is made of a material capable of withstanding contact with a corrosive etching solution such as hydrofluoric acid for a long period of time, i.e., having a high chemical-resistance. The cell 9 should permit transmission of a light beam having a wavelength within about a range of from 1.4 to 2.0 μm. Materials satisfying these requirements include a fluororesin. Favorably applicable fluororesin include PFA (ethylene tetrafluoride-perfluoroalkylvinylether copolymer resin), FEP (ethylene tetrafluoride-propylene hexafluoride copolymer resin), ETFE (ethylene tetrafluoride-ethylene copolymer resin), ECTFE (ethylene trifluorochloride-ethylene copolymer resin), PTFE (ethylene tetrafluoride resin), PCTFE (ethylene trifluoro-chloride resin), PVdF (vinylidene hydrofluoride resin), and VDF (vinyl hydrofluoride resin).

With the kind of solution to be measured and the use condition, the cell may be made of glass, sapphire, polypropylene resin, polycarbonate resin, or polyethylene terephthalate resin.

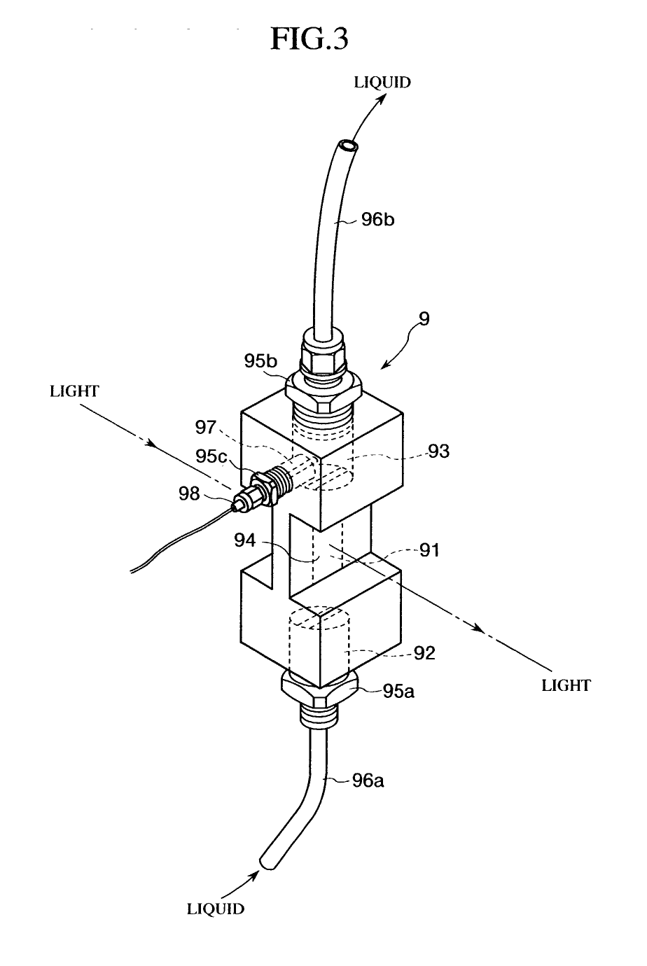

The flow cell shown in FIG. 3 is used as the cell 9 in this embodiment. This cell 9 is made of FEP, a fluororesin, and comprises a flow channel 91 through which a liquid can flow, an inflow port 92 through which the liquid is introduced into the flow channel 91, an outflow port 93 for discharging the liquid from the flow channel 91, and a detecting section 94 in which light is irradiated onto the liquid flowing in the flow channel. Pipes 96a and 96b connected to a supply source of an etching solution are connected to the inflow port 92 and the outflow port 93 by connecting means 95A and 95b to supply the liquid to the cell 9, and to discharge the liquid from the cell 9. For example, a joint using the inside diameter ring method (e.g., one made by FLOWELL Co.) having a high reliability may be used for the connecting means 95a and 95b, so as to prevent liquid leakage. In this embodiment, the chemical solution flowing through the cell 9 has an optical pass length of 2 mm.

Also in this embodiment, a side hole 97 running through in a direction perpendicular to the axial line of the flow channel 91 is provided to reach the outflow port 93, and liquid temperature detecting means (liquid temperature sensor) 98 for detecting temperature of the chemical solution flowing through the cell 9 penetrates into near the outflow port 93 via a connecting means 95c so as to come into contact with the solution flowing in the cell 9. As a liquid temperature detector 98, for example, a thermocouple coated with a chemical-resistant fluororesin (FEP) (for example, one made by Hayashi Denko Co., Model R5X (Pt 100 Ω (0° C.), 2 mA, class A, three-wire type) may be used. As connecting means 95c for connecting the liquid temperature sensor 98 to the cell 9, reliable connecting means free from the risk of liquid leakage (for example, one made by Flowell Co.: F-LOCK 30 Series MCT Screw, Model 3MCT2-C) can be used.

The output of the liquid temperature sensor 98 is entered into a, so called, microcomputer control circuit comprising a memory portion, a control portion and an operation portion (hereinafter simply referred to as the “microcomputer”) 45 provided in the control section 40, via a liquid temperature detecting circuit 51 (FIG. 2) provided in the control section 40. The output of the sensor 98 is used for calculation of the liquid concentration described later in detail.

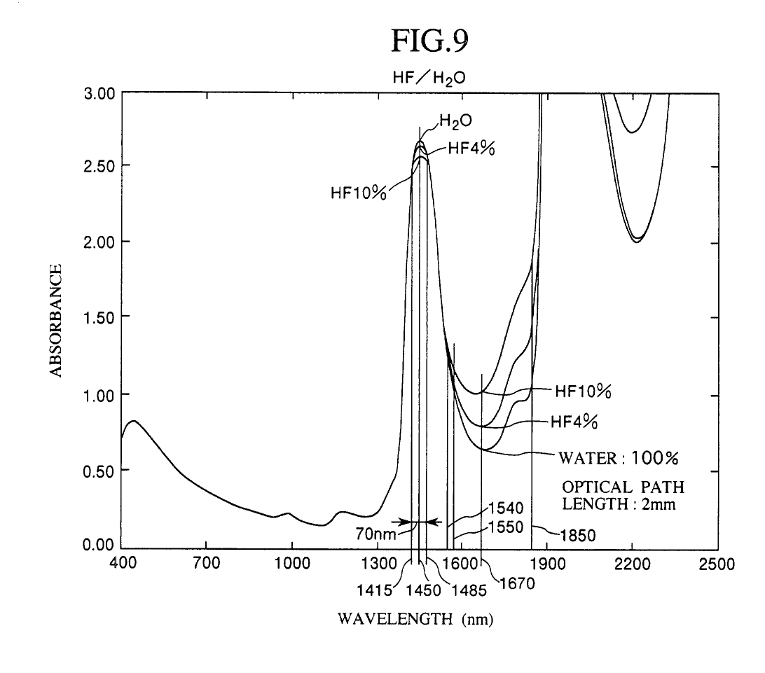

The light source used in the present invention may be selected according to the characteristics of near infrared spectra of aqueous solutions (chemical solutions) of hydrofluoric acid (HF), hydrochloride acid (HCl) and sulfuric acid (H₂SO₄) or the like used as, for example, an etching solution (FIGS. 9, 10 and 11). As is understood from FIGS. 9, 10 and 11, there are regions in which the difference in absorbance remarkably expresses, depending upon the concentration of the chemical solution within a wavelength region of from 1.4 to 2.0 μm (near a wavelength of 1.45 μm, near a wavelength region of from 1.55 to 1.9 μm, and near a wavelength region of from 1.9 to 2.0 μm). The near infrared absorption spectra of chemical solutions within about a wavelength region of from 1.4 to 2.0 μm takes almost uniform shape for all these aqueous solutions, and the extent of light absorption (absorbance) depends upon the kind of chemical solution and the concentration.

According to the present invention, therefore, near infrared light beams having a central wavelength within a range of from 1.4 to 2.05 μm, or preferably, within a range of from 1.42 to 1.48 μm, from 1.55 to 1.85 μm, or from 1.9 to 2.05 μm are irradiated onto the solution. A light source emitting such a light beam can be selected from a commercially available laser diodes (LD) and light emitting diodes (LED).

In the case of a single-constituent chemical solution, concentration of the single constituent in the solution can be detected through detection of the amount of light transmitting the solution by irradiating a near-infrared light beam having a central wavelength within a range of from 1.4 to 2.05 μm, or preferably, light of a wavelength band having a central wavelength within a range of from 1.42 to 1.48 μm, from 1.55 to 1.85 μm, or from 1.9 to 2.05 μm. In the case of a multi-constituent chemical solution, concentrations of individual constituents in the solution can be detected through detection of the amount of light transmitting the solution by irradiating near-infrared light beams of at least two different wavelength bands each having a central wavelength within a range of from 1.4 to 2.05 μm, or preferably, light beams of at least two different wavelength bands each having a central wavelength within a range of from 1.42 to 1.48 μm, from 1.55 to 1.85 μm, or from 1.9 to 2.05 μm.

In this embodiment, a light source having a central wavelength within a range of from 1.55 to 1.85 μm, producing a remarkable difference in absorbance under the effect of a difference in concentration of the chemical solution is used as the first light source 4A. More specifically, in this embodiment, a laser diode (LD) (made by NTT Electronics Co.: Model NKL 1601 CCA/TOA) having a central wavelength of the emitted light of 1.65±0.05 μm, and a wavelength region within a range of from 1.64 to 1.66 μm at 50% of the maximum amount of light (hereinafter simply refer to as the “light source having central wavelength of 1.65 μm”) is used. With this laser diode, there is available an amount of light of about 5 mW. Therefore, a larger amount of light at a particular wavelength is available in comparison with the case where a xenon lamp emitting a light beam having a wavelength region of from 0.16 to 2.0 μm and a spectral filter are simultaneously used for irradiating a light beam within a desired wavelength band to the sample chemical solution. Thus, it is possible to accurately detect a difference in absorbance caused by a difference in liquid concentration, because of a larger amount of light at a particular wavelength than in a case where a light beam within a desired wavelength band is irradiated onto a sample chemical solution. As described above, the difference in light absorption at a wavelength near a range of from 1.55 to 1.9 μm is based on ionic hydration.

As the light detector 11A provided in the transmitting light receiving section 11 and the reference light detector 13A provided in the reference light receiving section 13, a photodiode can suitably be used. In this embodiment, a photodiode (PD) sensitive to the light within a wavelength region of about 1.4 to 2.0 μm (InGaAs-PIN photodiode made by Hamamatsu Photonics Co.: commercial product name: G5851-01) is used as the light detector 11A and the reference light detector 13A. In this embodiment, as described later, temperature control is applied to the transmitting light receiving section 11 and the reference light receiving section 13. Therefore, a G5851-11 manufactured by Hamamatsu Photonics Co. having similar properties as those of the above-mentioned photodiode and having a built-in Peltier device may alternately be employed.

As shown in FIG. 2, the photodiodes (PD) for the light detector 11A and the reference light detector 13A are connected to a transmitting light PD amplifier 14a and a reference light PD amplifier 14b which are amplifying circuits, respectively. In this embodiment, the transmitting light PD amplifier 14a and the reference light PD amplifier 14b have substantially the same configuration and are formed on the same substrate (PD amplifying circuit board 14). It is not always necessary to form the transmitting light PD amplifier 14a and the reference light PD amplifier 14b on the same substrate. For the convenience of temperature control as described later, these PD amplifiers should preferably be provided near each other, or form them on the same substrate as in this embodiment.

The output of the light detector 11A and the reference light detector 13A, amplified by the transmitting light PD amplifier 14a and the reference light PD amplifier 14a is entered into a microcomputer 45 provided in the control section 40 via an A/D converter (not shown).

As a detecting circuit of the output of the photodiode, it is possible to suitably use a voltage detecting circuit which frequency-converts the amount of light sensed by the light detector 11A and the reference light detector 13A such as one disclosed in Japanese Patent Application Laid-Open No. H04-324328.

The amount of light thus sensed by the light detector 11A and the reference light detector 13A is converted into an electric signal, and the concentration calculating processing of the constituents to be measured in the solution is performed by the microcomputer 45.

First, the output corresponding to the amount of light sensed by the light detector 11A, i.e., the output of the transmitting light PD amplifier 14a (transmitting light PD output), and the output corresponding to the amount of light sensed by the reference light detector 13A, i.e., the output of the reference light PD amplifier 14a (reference light PD output) are entered into microcomputer 45, and it performs calculation for correcting variation in the amount of light of the first light source 4A.

More specifically, in this embodiment, the reference light PD output (mV) at a solution temperature of 25° C. is stored in a microcomputer 45 as the reference value Q (correction constant). Then the calculation is performed in accordance with the following formula:

$$\text{Detected voltage value} \text{(} \text{PD} \text{output)(mV)} = \text{(transmitting light} \text{PD} \text{output} / \text{reference light} \text{PD} \text{output)} \times \text{correction constant} \text{Q} \qquad ( 1 )$$

The result of the calculation is used for the subsequent concentration calculating processing as a detected value of PD output depending upon the liquid concentration. Unless otherwise defined in the following description, the detected voltage value after correction based on formula (1) is simply referred to as the “PD output” (or transmission coefficient).

When the light entering the reference light detector 13A is excessively strong, a filter for reducing the amount of incident light may be provided in the reference light receiving section 13. In this case, it suffices to adopt the output of the reference light detector 13A, for example, at 25° C. in the use of a similar filter as the correction constant Q.

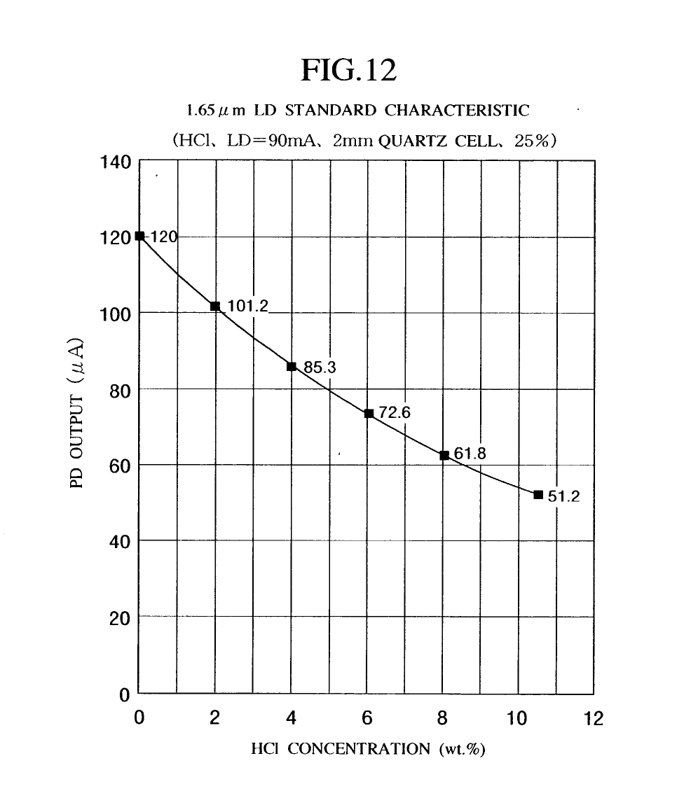

The case where the concentration of a single-constituent chemical solution is detected by using, for example, the first light source of the first projecting section 4 will now be described. FIG. 12 illustrates PD output characteristic in a case where the amount of transmitting light of a sample solution is measured by using a quartz cell in place of the above-mentioned flow cell 9, introducing hydrochloric acid (HCl) with various concentrations as a solution to be measured, and irradiating a near infrared ray having a central wavelength of 1.65 μm from the first light source 4A. In FIG. 12, the ordinate represents the transmitting light PD output in the form of a current value (μA), and the abscissa, the concentration (wt. %) of hydrochloric acid. FIG. 12 shows the result in a case where, by use of a quartz cell having an optical path length of 2 mm, the first light source 4A is constant-current-driven of 90 mA, and a feedback resistance of the transmitting light PD amplifier 14a and the reference light PD amplifier 14b is 4.3 kΩ.

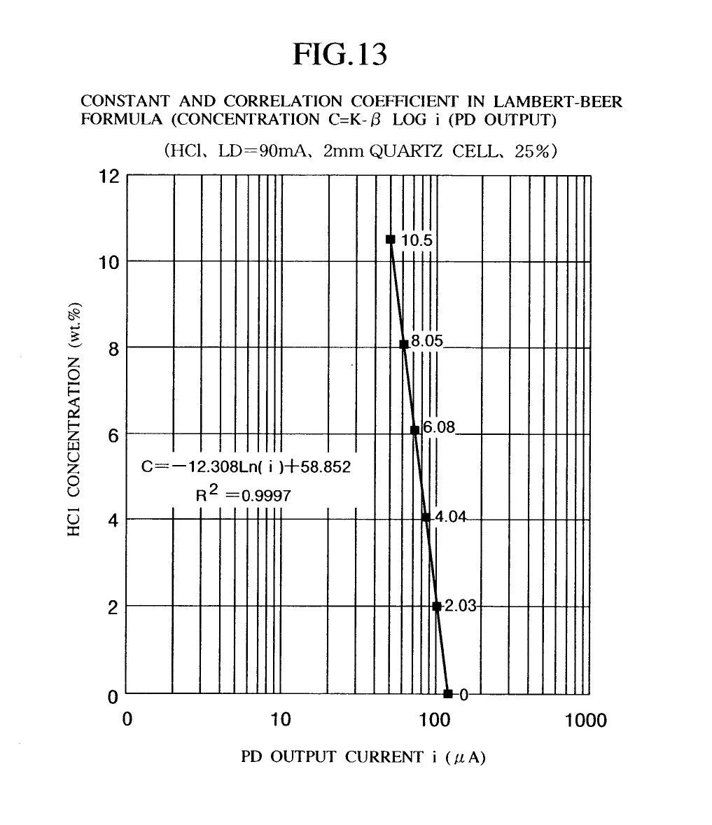

As shown in FIG. 12, there is a correlation between the PD output and the solution (HCl) concentration. As is clear from FIG. 13 showing a logarithmic graph representation (abscissa: PD output; ordinate: HCl concentration), there is suggested possibility to derive a formula based on Lambert-Beer's rule for the liquid concentration at a certain temperature. In the graph of FIG. 13, there is a very good correlation as typically represented by a correlation coefficient of 0.9997 as expressed by R² between the PD output and the liquid concentration.

That is, in the liquid concentration detecting apparatus 1 of this embodiment, the PD output and the concentration of a constituent contained in the chemical solution to be measured can be expressed by the following formula:

C=K−β1n (V) (2)

where, C: concentration of chemical solution (wt. %)

V: PD output (mV) (or transmission coefficient τ).

As described above, the shape of absorption spectrum in the near infrared region having a wavelength of about 1.4 to 2.0 μm is similar for various chemical solutions, and the extent of absorption depends upon the kind of chemical solution and the concentration of the chemical solution (FIGS. 9 to 11). Therefore, formula (2) is valid for all chemical solutions to be measured of the chemical solution concentration detecting apparatus 1 of the invention, and the coefficients K and β in formula (2) vary between chemical solutions. The coefficients K and β are intrinsic to each chemical solution for the light of a particular wavelength band, and these coefficients K and β are expressed by the following formulae which are functions of temperature:

K=at+b (3)

β=mt+n (4)

where, t: liquid temperature (° C.).

In formulae (3) and (4), a, b, m and n are constants unique to each chemical solution for the light of a particular wavelength band. These constants are previously determined for individual chemical solutions and stored in the microcomputer 45 provided in the control section 40, or determined prior to measurement by a calibrating circuit 49 provided in the control section 40 in accordance with a prescribed calibrating procedure described later.

According to the liquid concentration detecting apparatus 1 of this embodiment, therefore, the microcomputer 45 provided in the control section 40 calculates the coefficients K and β of formula (2) by means of formulae (3) and (4) from the temperature of the chemical solution flowing in the cell 9 as detected by the liquid temperature sensor 98. The concentration of the chemical solution can be detected by performing calculation in accordance with formula (2), using the PD output calculated in accordance with formula (1) on the basis of values of output of the light detector 11 A and the reference light detector 13A. It is needless to mention that the calculation sequence is not limited to that described above.

It is naturally possible, as required, to previously set a K-value and a β-value themselves as constants in the microcomputer 45, and perform calculations by use of these values. In this case, temperature measurement of the chemical solution flowing through the cell 9 can be omitted.

The concentration of a single-constituent chemical solution can thus be detected through the configuration as described above.

In order to detect concentrations of constituents of a multiple-constituent mixed chemical solution in accordance with the invention, it is necessary to irradiate to the solution a light beam of a wavelength band different from that of the aforementioned first light source 4A, having a central wavelength within a range of 1.4 to 2.05 μm. In the liquid concentration detecting apparatus 1 of this embodiment, this is achieved by providing a second projecting section 6 having a second light source 6A in addition to the above first projecting section. Concentration detection of a binary chemical solution using also the second projecting section 6 will now be described.

As is understood with reference to FIGS. 9 to 11, in the absorbance spectra in the near infrared region of a wavelength within a range of from 1.4 to 2.0 μm with various chemical solutions such as hydrofluoric acid (HF), hydrochloric acid (HCl) and sulfuric acid (H₂SO₄), the absorbance near a wavelength of 1.45 μm considerably varies with the difference in concentration of the solution.

Absorption of light of a wavelength near 1.4 μm by these solutions falls under the wavelength band belonging to oxygen-hydrogen coupled group of water (overtone of O-H stretching vibration), as described above. The above-mentioned formula (2) is valid also for absorption of light having a wavelength near 1.4 μm, or preferably, a central wavelength within a range of from 1.42 to 1.48 μm by a chemical solution. However, since absorption of light falling under this wavelength band varies with the quantity of water itself, as is known from FIGS. 9 to 11, the sign of coefficient P regarding constituents of a chemical solution to be measured is contrary to that in the case of absorption of light having a central wavelength within a range of from 1.55 to 1.85 μm and from 1.9 to 2.05 μm. The degree of change in absorbance caused by a difference in liquid concentration for the light of this wavelength band is different from the degree of change for the light of the above-mentioned first light source 4A (central wavelength: 1.65 μm).

As described later in detail, it is possible to detect the amount of water itself (water concentration) of the aqueous solution by detecting absorption of light having a central wavelength within a range of from 1.42 to 1.48 μm.

In this embodiment, a light source emitting a light beam of this wavelength band, i.e., having a central wavelength within a range of from 1.42 to 1.48 μm is used as a second light source 6A of the second projecting section 6. More specifically, as the second light source 6A in this embodiment, a laser diode (LD) (made by NTT Electronics Co.: Model NKL1402 TOB) having a central wavelength of 1.45±0.015 μm, and having a wavelength region within a range of from 1.44 to 1.46 μm at 50% of the maximum amount of light (hereinafter simply refer to as the “light source having a central wavelength of 1.45 μm”) is used. This laser diode gives a high output of at least 10 mW (≧10 mW), thus permitting accurate detection of the difference in absorbance caused by the difference in the amount of water.

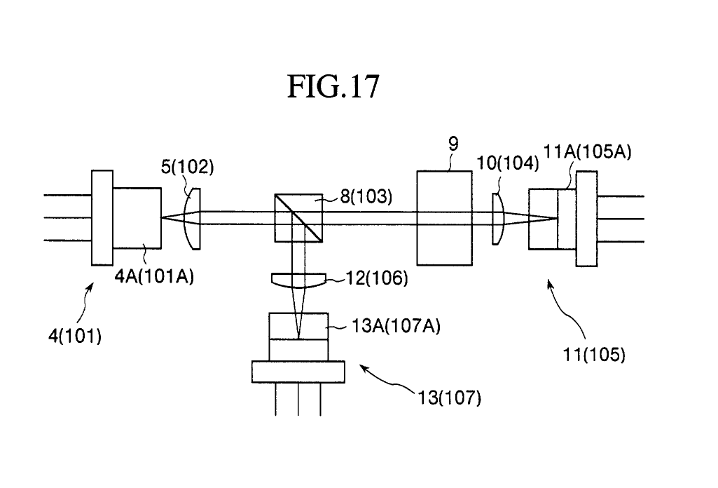

In a configuration in which light beams of at least two different wavelength bands are to be irradiated onto the liquid by providing a plurality of light sources, it is possible in principle to detect concentration of each constituent of a binary mixed chemical solution by providing another set of the above-mentioned optical components including projecting sections, a beam splitter, a transmitting light receiving section and a reference light receiving section, irradiating light from each projecting section onto the solution flowing in the cell 9, and arranging these components so as to permit measurement of the amount of transmitting light. This is achievable in a configuration in which a detecting section 94 of the cell 9 is extended in the liquid flowing direction, and two sets of the above-mentioned optical components as shown in FIG. 17 each including projecting sections 4, a beam splitter 8, a transmitting light receiving section 11 and a reference light receiving section 13 are arranged along with the liquid flowing direction.

In this embodiment, however, the configuration can be simplified by reducing the number of optical components even when a plurality of light sources are provided by adopting the configuration described in the following paragraphs.

According to this embodiment, the second projecting section 6 is arranged so that the optical axes of light beams emitted from the first projecting section 4 and the second projecting section 6 cross each other at right angles at the beam splitter 8. The beam having passed through the beam splitter 8 from among the light beams emitted from the second light source 6A runs in the same direction as that of the light beam from the first light source 4A reflected by the beam splitter 8, and enters the reference light detector 13A. The beam reflected by the beam splitter 8 from among the beams emitted from the second light source 6A runs, on the other hand, in the same direction as that from the first light source 4A having passed through the beam splitter 8, enters the cell 9, and the beam having passed through the solution is sensed by the light detector 11A. A collimator lens 7 for irradiating the light emitted from the light source as parallel beams to the beam splitter 8 is provided also in the second projecting section 6 as in the first projecting section.

By adopting the arrangement configuration as described above, it is possible to commonly use the optical components, other than the pair of projecting sections each having light sources, including the beam splitter 8, the light detector 11A of the transmitting light receiving section 11, and the reference light detector 13A of the reference light receiving section 12A, as well as the amplifying circuit boards 14 (the transmitting light PD amplifier 14a and the reference light PD amplifier 14b) of the output of the light detector 11A and the reference light detector 13A formed on the same substrate in this embodiment. In that arrangement configuration, the liquid concentration detecting apparatus 1 having two projecting sections permits detection of the concentration of a binary chemical solution. As a result, it is possible to largely reduce the cost and simplify the configuration.

As will be described later in detail, by arranging the first projecting section 4 and the second projecting section 6 in the configuration of this embodiment, and using the other optical components in common for the both projecting sections 4 and 6, there is also available an advantage of easy temperature control of the optical components including reduction of the number of parts to be temperature-controlled.

As is clear from the concentration calculating method described later, it is necessary to take out, for use in the calculation, the respective PD outputs for the light emitted from the first light source 4A and the second light source 6A. That is, in this embodiment, it is necessary to take out the PD output (V_{1 65}) for the light having a central wavelength of 1.65 μm (first light source 4A) and the PD output (V_{1.45}) for the light having a central wavelength of 1.45 μm (second light source 6A), for use in the calculation. When arranging the first projecting section 4 and the second projecting section 6 in the configuration of this embodiment, however, if the both light sources 4A and 6A are always turned on, it is impossible to take out PD outputs for individual light beams from the light sources 4A and 6A individually.

It is conceivable to take out the PD outputs for each light beam from the light sources 4A and 6A by turning ON/OFF the first light source 4A and the second light source 6A at a prescribed timing, and for example, switching over turn-on between the light sources 4A and 6A. According to a study carried out by the present inventor, however, it takes much time from the start of power supply until stabilization of output (rise time) for, for example, the LD serving as a light source: from several to several tens of minute in some cases. When accurately detecting the liquid concentration, therefore, repetition of ON/OFF of the light source poses a problem in stability of the amount of light of the light sources. Repetition of ON/OFF of the light sources, in the case of an LD for example, leads to a problem of a shorter service life. If a light source overcoming these problems is available, the PD output for the light from the both light sources can be suitably taken out by turning ON/OFF the light sources at a prescribed timing. As far as the present inventor knows, however, such a light source is still unavailable.

In this embodiment, therefore, while always turning on the first light source 4A and the second light source 6A, the light emitted from one light source is mechanically cut off (chopping) at a prescribed timing, and the PD output for the light of each light source is extracted.

More specifically, according to this embodiment, light cutoff means 15 is provided on the optical path from the second light source 6A to the beam splitter 8, and the light emitted from the second light source 6A is chopped at a prescribed timing, while the first light source 4A and the second light source 6A are simultaneously turned on. The PD output for the light from each of the light sources 4A and 6A is extracted by subtracting the PD output when only the light from the first light source enters the light detector 11A and the reference light detector 13A as a result of mechanical interruption of the light emitted from the second light source 6A, from the PD output when beams from the first light source 4A and the second light source 6A simultaneously enter the light detector 11A and the reference light detector 13A (value after correction by formula (1)). That is, the PD output corresponding to the amount of light having passed through the sample of the light from the second light source 6A is obtained in accordance with the following formula:

V_{II}=V_{(I+II)}−V_{I} (5)

where,

V_{I}: PD output (mV) for only the light from the first light source 4A (V_{1 65} in this embodiment);

V_{II}: PD output (mV) for only the light from the second light source 6A (V_{1.45} in this embodiment);

V_{(I+II)}: Total PD output (mV) for the light beams from the first light source 4A and the light from the second light source 6A.

As the light cutoff means 15, an electric shutter of which opening and closing are conducted in response to a pulse signal, such as an electromagnetic shutter (Model EC-598) made by Copal Co., or an electronic shutter (Model 846HP) made by Newport Co. are suitably applicable. Alternately, it is also possible to adopt a configuration in which passage and cutoff of light are repeated by arranging a disk having slits provided at appropriate intervals on the optical path from the light source and rotation-driving this disk by a motor (for example, the optical chopper made by Scitec Instruments Co.). Chopping by means of a shutter mechanism is desirable because of a simple configuration and easy control of the chopping interval.

The above-mentioned electromagnetic shutter made by Copal Co. is used in this embodiment. The shutter is opened and closed by a pulse (5 V) of about 20 ms by means of a light cutoff means control circuit (not shown) controlled by the microcomputer 45 of the control section 40. This state is kept for 1 to 10 seconds, during which stabilization of output of the light detector 11A and the reference light detector 13A is waited for. Upon stabilization, data of the amount of light (output voltage) is incorporated into the microcomputer 45.

The calculating method of concentration of individual constituents of a binary mixed chemical solution by means of the first light source (central wavelength: 1.65 μm) and the second light source (central wavelength: 1.45 μm) in the liquid concentration detecting apparatus 1 of this embodiment will now be described.

Concentration calculating technique 1

The concentration calculating technique 1 described in the following paragraphs is an approximate calculating method. It is applicable in response to a required measuring accuracy, constituents of a chemical solution to be measured.

Consideration will now be made about a case where concentrations C_{A} (wt. %) and C_{B} (wt. %) of constituents A and B (for example, hydrofluoric acid and nitric acid) contained in a mixed chemical solution to be measured such as an etching solution is to be determined. Additivity is valid for concentrations A and B in a mixed solution. More specifically, if it is assumed that a new constituent is not formed through reaction of the constituents A and B, then, concentrations C of the mixed solution would be:

C=C_{A}+C_{B} (6)

(i) Absorption of the light having a central wavelength of 1.45 μm by a binary mixed chemical solution may be approximately considered as follows. On the basis of the fact, as described above, that absorption of the light having a central wavelength of 1.45 μm by a chemical solution is within an absorption wavelength band belonging to the oxygen-hydrogen coupled group of water, the relationship expressed by the above-mentioned formula (2) is applicable to the relationship between the PD output (V_{1.45}) and the quantity of water C_{W} (wt. %) in terms of the quantity of water itself C_{W} (wt. %). The water content C_{W} (wt. %) in the mixed chemical solution is measured by absorption of light having a central wavelength of 1.45 μm, and the balance is deemed to be the total concentration C (wt. %) of constituents A and B contained in the mixed chemical solution.

C_{W}=100−C=K_{W}−β_{W} ln(V_{1.45}) (7)

C=C_{A}+C_{B}=100−(K_{W}−β_{W} ln(V_{1.45})) (8)

where,

V_{1.45}: the PD output relative to the light having a central wavelength of 1.45 μm, exhibited by the mixed chemical solution.

(ii) Absorption of the light having a central wavelength of 1.65 μm by a binary mixed chemical solution is considered as follows. If it is assumed that a mixed chemical solution is obtained by mixing single-constituent chemical solutions A and B having respective concentrations C_{A} (single) (wt. %) and C_{B} (single) (wt. %) at mixing ratios X (wt/wt. %) and Y (wt/wt. %), then:

C_{A}=C_{A(single)}·X/100 (9)

C_{B}=C_{B(single)}·Y/100 (10)

X+Y=100 (11)

are valid, and from formula (6), the following formula (12) is available:

C_{A(single)}·X/100+C_{B(single)}·Y/100=C_{A}+C_{B}=C (12)

Since formula (2) is valid for all the constituents to be measured in the chemical solution, as described above, concentrations CA(single) and CB(single) of single-constituent chemical solutions A and B for light having a central wavelength of 1.65 μm would be expressed by:

C_{A(single)}=K_{A}−β_{A} ln(V_{A}) (13)

C_{B(single)}=K_{B}−β_{B} ln(V_{B}) (14)

where,

V_{A}: PD output relative to the light having a central wavelength of 1.65 μm exhibited when constituent A is a single-constituent; and

V_{B}: PD output relative to the light having a central wavelength of 1.65 μm exhibited when constituent B is a single-constituent.

If it is approximately assumed that:

V_{A}=V_{B}=V_{1.65}

where,

V_{1.65}: PD output relative to the light having a central wavelength of 1.65 μm exhibited by the mixed chemical solution,

formula (12) is rewritten into the following formulae (15) and (16) from the relationship expressed by formulae (13), (14) and (11):

(K_{A}−β_{A} ln(V_{1.65}))·X+(K_{B}−β_{B} ln(V_{1.65}))·(100−X)=100C (15)

(K_{A}−β_{A} ln(V_{1 65}))·(100−Y)+(K_{B}−β_{B} ln(V_{1 65}))·Y=100C (16)

There are therefore available:

X=100(C−K_{B}+β_{B} ln(V_{1.65}))/{(K_{A}−K_{B})+(β_{B}−β_{A})ln(V_{1.65})} (17)

Y=100(C−K_{A}+β_{A} ln(V_{1 65}))/{(K_{B}−K_{A})+(β_{A}−β_{B})ln(V_{1.65})} (18)

Therefore, concentrations C_{A} and C_{B} of constituents A and B contained in the mixed chemical solution as expressed by formulae (9) and (10) would be, from the relationship represented by formulae (17), (18) and (8), as follows:

$$\begin{matrix}\begin{matrix}{C}_{A} = {C}_{A ( single )} \cdot X / 100 \\ = \{ {K}_{A} - {β}_{A} ln ( {V}_{1.65} ) \cdot ( C - {K}_{B} + {β}_{B} ln ( {V}_{1 \; 65} ) ) \} / \\ \{ ( {K}_{A} - {K}_{B} ) + ( {β}_{B} - {β}_{A} ) \cdot ln ( {V}_{1.65} ) \} \\ = [ ( {K}_{A} - {β}_{A} ln ( {V}_{1.65} ) ) \cdot \{ 100 - ( {K}_{B} + {K}_{W} ) + \\ ( {β}_{B} ln ( {V}_{1 \; 65} ) + {β}_{W} ln ( {V}_{1 \; 45} ) ) \} ] / \\ \{ ( {K}_{A} - {K}_{B} ) + ( {β}_{B} - {β}_{A} ) \cdot ln ( {V}_{1.65} ) \}\end{matrix} & ( 19 ) \\ \begin{matrix}{C}_{B} = {C}_{B ( single )} \cdot Y / 100 \\ = - \{ ( {K}_{B} - {β}_{B} ln ( {V}_{1.65} ) ) \cdot ( C - {K}_{A} + {β}_{A} ln ( {V}_{1.65} ) ) \} / \\ \{ ( {K}_{A} - {K}_{B} ) + ( {β}_{B} - {β}_{A} ) \cdot ln ( {V}_{1.65} ) ) \} \\ = - [ ( {K}_{B} - {β}_{B} ln ( {V}_{1 \; 65} ) ) \cdot \{ 100 - ( {K}_{A} + {K}_{W} ) + \\ ( {β}_{A} ln ( {V}_{1 \; 65} ) + {β}_{W} ln ( {V}_{1.45} ) ) \} ] / \\ \{ ( {K}_{A} - {K}_{B} ) + ( {β}_{B} - {β}_{A} ) \cdot ln ( {V}_{1 \; 65} ) \}\end{matrix} & ( 20 )\end{matrix}$$

Concentrations C_{A} and C_{B} of constituents A and B contained in the mixed chemical solution are calculable from the thus obtained formulae (19) and (20).

Coefficients K and β in the concentration calculating formulae are intrinsic to individual chemical solutions for the light within a certain wavelength band (light having a central wavelength of 1.65 μm in this embodiment). As described above, these coefficients K and β are functions of temperature as follows:

K_{A}=at +b (21a)

β_{A}=mt+n (21b)

K_{B}=ct+d (22a)

β_{B}=ot+p (22b)

K_{W}=et+f (23a)

β_{W}=qt+r (23b)

where, t: temperature of the mixed chemical solution (° C.).

In the above-mentioned formulae (21 a, 21b) and (22a, 22b), a, b, c, d, m, n, o and p are constants intrinsic to the individual chemical solutions for the light having a central wavelength of 1.65 μm. In formula (23a, 23b), e, f, q and r are constants intrinsic to water for the light having a central wavelength of 1.45 μm. These constants are predetermined for the individual chemical solutions and stored in a microcomputer 45 provided in the control section 40, or determined prior to measurement by a calibrating circuit 49 provided in the control section 40 in accordance with a prescribed calibrating procedure described later.

According to the liquid concentration detecting apparatus 1 of this embodiment, therefore, temperature of the chemical solution flowing through the cell 9 is detected by means of a liquid temperature sensor 98 provided in the cell 9, and coefficients K and β of formulae (21 a, 21b), (22a, 22b) and (23a, 23b) are calculated by the microcomputer 45 provided in the control section 40. The microcomputer 45 detects a PD output (V_{1.65}) for the light from the first light source 4A and a PD output (V_{1.45}) for the light from the second light source 6A extracted at a prescribed timing in accordance with formula (5). Calculation by formulae (19) and (20) permits detection of concentration C_{A} of constituent A and concentration C_{B} of constituent B contained in the mixed chemical solution.

It is naturally possible, as required, to previously set a K-value and a β-value themselves as constants in the microcomputer 45, and perform calculations by use of these values. In this case, temperature measurement of the chemical solution flowing through the cell 9 can be omitted.

Concentration calculating technique 2

When concentration calculation of a higher accuracy is required, the following concentration calculating technique 2 can be applied.

In the concentration calculating technique 2, concentrations of the individual constituents of the mixed chemical solution to be measured are calculated by use of the convergence calculating method.

Consider a case where concentrations C_{A} (wt. %) and C_{B} (wt. %) of constituents A and B (for example, hydrofluoric acid, nitric acid or the like) contained in a mixed chemical solution to be measured such as an etching solution is determined. A binary mixed chemical solution (a total concentration C (wt. %) of constituents A and B in the mixed chemical solution) is assumed to be formed by mixing a single-constituent chemical solutions A and B at a mixing ratio X:Y.

As described above, the relationship between concentrations of the single-constituent chemical solutions A and B and the amount of transmitting light of the light having a central wavelength of 1.65 μm or 1.45 μm (PD output in this embodiment) is as expressed by formula (2).

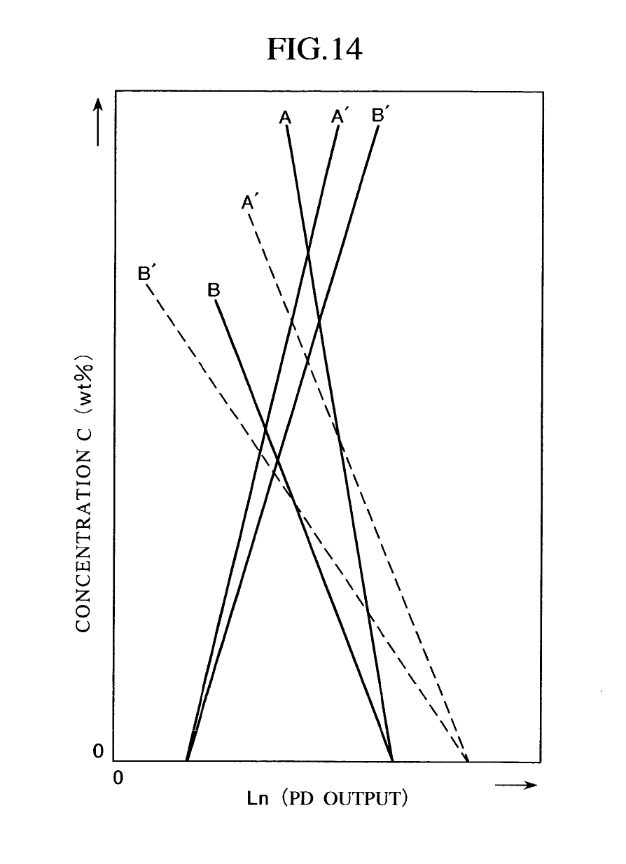

For example, the concentration calculating formulae of single-constituent chemical solutions A and B for absorption of the light having a central wavelength of 1.65 μm according to formula (2) are assumed to be represented by straight lines (solid lines) A and B in FIG. 14, respectively. In this case, straight lines A and B can be deemed to represent concentration C_{A} of constituent A and concentration C_{B} of constituent B in a mixed chemical solution comprising only a single-constituent chemical solution A or B.

It is furthermore assumed that the concentration calculating formulae of single-constituent chemical solutions A and B for absorption of the light having a central wavelength of 1.45 μm according to formula (2) are represented by straight lines (solid lines) A′ and B′ in FIG. 14, respectively. In this case, straight lines A′ and B′ can be deemed to represent concentration C_{A}′ of constituent A and concentration C_{B}′ of constituent B in the mixed chemical solution comprising only a single-constituent chemical solution A or B.

That is, if straight lines (solid lines) A, B, A′ and B′ in FIG. 14 are expressed, respectively, by:

C_{A}=K_{A}−β_{A} ln(V_{A}) (24)

C_{B}=K_{B}−β_{B} ln(V_{B}) (25)

C_{A}′=K_{A}′−β_{A}′ ln(V_{A}′) (26)

C_{B}′=K_{B}′−β_{B}′ ln(V_{B}′) (27)

where,

V_{A}: PD output relative to the light having a central wavelength of 1.65 μm, exhibited when constituent A is a single constituent;

V_{B}: PD output relative to the light having a central wavelength of 1.65 μm, exhibited when constituent B is a single constituent;

V_{A}′: PD output relative to the light having a central wavelength of 1.45 μm, exhibited when constituent A is a single constituent; and

V_{B}′: PD output relative to the light having a central wavelength of 1.45 μm, exhibited when constituent B is a single constituent, then, irrespective of in what mixing ratio X:Y, single constituents A and B are mixed in what concentrations into a binary mixed chemical solution, the relationship between the total concentration C (wt. %) of constituents A and B in the mixed chemical solution and the PD output (V_{1.65}) upon irradiation of the light having a central wavelength of 1.65 μm onto the mixed chemical solution (plot (C, V_{1 65})) is located between straight lines (solid lines) A and B. Similarly, the relationship between the total concentration C′ (wt. %) of constituents A and B in the mixed chemical solution and the PD output (V_{1.45}) upon irradiation of the light having a central wavelength of 1.45 μm (plot (C′, V_{1.45})) is located between straight lines (solid lines) A′ and B′.

On the basis of this principle, in this embodiment, the following conditions for convergence calculation can be introduced.

(i) Conditions for convergence calculation:

(ln(V_{A})−ln(V_{1.65})):(ln(V_{1 65})−ln(V_{B}))=Y:X (28)

(ln(V_{B}′)−ln(V_{1.45})):(ln(V_{1.45})−ln(V_{A}′))=X:Y (29)

where, X+Y=1. Because C_{A}=C_{A}′ and C_{B}=C_{B}′:

C_{A}+C_{B}=C_{A}′+C_{B}′(=C=C′) (30)

(ii) Calculation formula of V_{B}, V_{A}′ and V_{B}′:

(ii-a) From formula (28):

ln(V_{A}/V_{1.65})·X=ln(V_{1 65}/V_{B})·(1−X) (31)

ln(V_{1 65}/V_{B})=ln(V_{A}/V_{1 65})·X/(1−X)

V_{1.65}/V_{B}=exp{ln(V_{A}V_{1.65})·X/(1−X)}

Therefore,

V_{B}=V_{1.65}/exp{ln(V_{A}/V_{1.65})·X/(1−X)} (32)

(ii-b) From formula (29):

ln(V_{B}′V_{1.45})·(1−X)=ln(V_{1 45}/V_{A}′)·X

ln(V_{B}′/V_{1.45})={ln(V_{1.45}/V_{A}′)·X/(1−X)}

Therefore,

V_{B}′=V_{1 45}·exp{ln(V_{1.45}/V_{A}′)·X/(1−X)} (33)

(Furthermore, V_{B}′ is determined by incorporation of formula (34) described later into formula (33)).

(ii-c) Since C_{A}=C_{A}′, from formulae (24) and (26):

ln(V_{A}′)={(K_{A}′−K_{A})+β_{A} ln(V_{A})}/β_{A}′

Therefore,

V_{A}′=exp[{(K_{A}′−K_{A})+β_{A} ln(V_{A})}/β_{A}′] (34)

(iii) Concentration calculation:

By assuming an initial value V_{A0} of V_{A} and an initial value X₀ of X, initial values V_{B0}, V_{A0}′ and V_{B0}′ of V_{B}, V_{A}′ and V_{B}′ are calculated from formulae (32), (33) and (34). Then, C_{B}, C_{A}′ and C_{B}′ are calculated from formulae (24) to (27), respectively.

(iv) Convergence calculation:

In this embodiment, convergence calculation is performed until:

|(C_{B}−C_{B}′)/C_{B}′| (35)

|(X(initial value)−X(calculated value))/X(calculated value)| (36)

become within a prescribed range, or preferably unlimitedly approach zero.

For example, convergence calculation is continued until the following formulae become valid:

|(C_{B}−C_{B}′)/C_{B}|≦0.001

|(X(initial value)−X(calculated value))/X(calculated value)|□0.001

That is, X (calculated value) is calculated in accordance with the following formula derived from formula (31):

X=ln(V_{1.65}/V_{B})/{ln(V_{A}/V_{1.65})+ln(V_{1.65}/V_{B}} (37)

where, in formula (37), V_{A} and V_{B} represent V_{A0} and V_{B0} in (iii) above.

The calculated value of V_{A} is calculated by the following formula obtained from formula (24):

V_{A}=exp{(K_{A}−C_{A})/β_{A}} (38)

C_{A} in formula (38) is calculated from the following formula resulting from formula (30):

$$\begin{matrix}{C}_{A} = ( {C}_{A}^{′} + {C}_{B}^{′} ) - {C}_{B} \\ = ( {K}_{A}^{′} + {K}_{B}^{′} - {K}_{B} ) + \{ {β}_{B} ln ( {V}_{B} ) - {β}_{A}^{′} ln ( {V}_{A}^{′} ) - {β}_{B}^{′} ln ( {V}_{B}^{′} ) \}\end{matrix} \qquad ( 39 )$$

where, in formula (39), V_{B}, V_{A}′ and V_{B}′ represent initial values V_{B0}, V_{A0}′ and V_{B0}′ in item (iii).

In convergence calculation, V_{A} and X calculated by formulae (37) and (38) are brought back as initial values of V_{A} and X in item (iii), and the subsequent calculation steps are repeated.

(v) Determination of C_{A} and C_{B}:

Values of C_{A} and C_{B} upon convergence within a prescribed range through convergence calculation as described above are determined as concentrations of constituents A and B contained in the mixed chemical solution.

The range within which a value is to be converged by convergence calculation may appropriately be selected in view of the required measuring accuracy, the calculating speed and the like. For example, when convergence calculation is continued until the deviation becomes under 0.001 as described above, a measuring accuracy of 0.01 wt. % can be ensured. A microcomputer 45 capable of performing convergence calculation within such a range at a high speed is commercially available. The procedure of convergence calculation may be implemented by setting the procedure in the form of a program in the microcomputer 45, or using a commercially available calculation software program. Since programming the convergence calculation procedure or execution by use of a calculation software program itself is a technique known to a person skilled in the art, further description is omitted here.

In the above-mentioned convergence calculation, arbitrary values (positive real numbers) may be used as initial value V_{A0} of V_{A} and initial value X₀ of X. This is not limitative, but it is convenient to use PD output V_{1.65} exhibited by the mixed chemical solution to the light having a central wavelength of 1.65 μm as an initial value V_{A0}, and 50 (%) as an X₀.

Coefficients K and β in the concentration calculating formulae are intrinsic to individual chemical solutions relative to the light of a wavelength band (light of a central wavelength of 1.65 μm in this embodiment). These coefficients K and β are functions of temperature and are expressed as follows:

K_{A}=at+b (40a)

β_{A}=mt+n (40b)

K_{B}=ct+d (41a)

β_{B}=ot+p (41b)

K_{A}′=a′t+b′ (42a)

β_{A}′=m′t+n′ (42b)

K_{B}′=c′t+d′ (43a)

β_{B}′=o′t+p′ (43b)

where, t: temperature (° C.) of a mixed chemical solution. In the above-mentioned formulae (40a, 40b) and (41a, 41b), a, b, c, d, m, n, o and p represent constants intrinsic to the individual chemical solutions relative to the light having a central wavelength of 1.65 μm. In formulae (42a, 42b) and (43a, 43b), a′, b′, c′, d′, m′, n , o and p′ represent constants intrinsic to the individual chemical solutions relative to the light having a central wavelength of 1.45 μm.

These constants are predetermined for the individual chemical solutions, and stored in the microcomputer 45 provided in the control section 40, or determined by the calibrating circuit 49 provided in the control section 40 prior to measurement in accordance with a prescribed calibrating procedure described later.

According to the liquid concentration detecting apparatus 1 of this embodiment, therefore, temperature of the chemical solution flowing through the cell 9 is detected by a temperature sensor 98 provided in the cell 9, and the microcomputer 45 provided in the control section 40 calculates coefficients K and β of formulae (40a, 40b), (41 a, 41 b), (42a, 42b) and (43a, 43b). The microcomputer 45 detects PD output (V_{1 65}) for the light from the first light source 4A, and PD output (V_{1 45}) for the light from the second light source 6A extracted at a prescribed timing in accordance with formula (5). By performing calculation in accordance with the above-mentioned convergence calculating technique, it is possible to detect concentration C_{A} of constituent A and concentration C_{B} of constituent B contained in the mixed chemical solution.

Concentration calculating technique 3

When concentration calculation of a higher accuracy is required, the following concentration calculating technique can be applied.

Additivity is valid in the mixing of chemical solutions to be measured by the liquid concentration detecting apparatus 1, without changing individual constituents through a reaction to other material or without evaporation or disappearance through decomposition.

Consideration will now be made about a case where a certain multiple-constituent composition is obtained by mixing single-constituent chemical solutions (components). Then, on the basis of the fact that, for the light of a particular wavelength, absorbance for multiple-constituent mixed chemical solution is equivalent to the sum of absorbance for each component, the calculating formulae for calculating the concentrations of each component can be led from absorbance for multiple-constituent mixed chemical solution by a reverse operation.

Now, it is assumed that the binary mixed chemical solution (volume :m+n) is obtained by mixing arbitrary single-constituent chemical solutions A and B at mixing ratio m:n.

Regarding the first light (wavelength: 1.65 μm):

((m+n)/m)·C_{A}=K_{A}−β_{A} Ln(τ_{A})

((m+n)/n)·C_{B}=K_{B}−β_{B} Ln(τ_{B})

Regarding the second light (wavelengths: 1.45 μm):

((m+n)/m)·C_{A}=K_{A}′−β_{A}′ Ln(τ_{A}′)

((m+n)/n)·C_{B}=K_{B}′−β_{B}′ Ln(τ_{B}′)

When the chemical solution A [concentration: ((m+n)/m)·C_{A}] and the chemical solution B [concentration: ((m+n)/n)·C_{B}] are mixed at mixing ratio m: n, absorbance for the mixed solution [volume: m+n volume] is as follows:

$$\text{Regarding the first light:}$$

$$\begin{matrix}\begin{matrix}- Ln ( τ ) = - \{ ( m / ( m + n ) ) \cdot Ln ( {τ}_{A} ) + ( n / ( m + n ) ) \cdot Ln ( {τ}_{B} ) \} \\ = - \{ ( m / ( m + n ) ) ( {K}_{A} - ( ( m + n ) / m ) \cdot {C}_{A} ) / {β}_{A} + \\ ( n / ( m + n ) ) ( {K}_{B} - ( ( m + n ) / n ) \cdot {C}_{B} ) / {β}_{B} \}\end{matrix} \\ \text{Regarding the second light:} & ( 106 ) \\ \begin{matrix}- Ln ( {τ}^{′} ) = - \{ ( m / ( m + n ) ) \cdot Ln ( {τ}_{A}^{′} ) + ( n / ( m + n ) ) \cdot Ln ( {τ}_{B}^{′} ) \} \\ = - \{ ( m / ( m + n ) ) ( {K}_{A}^{′} - ( ( m + n ) / m ) \cdot {C}_{A} ) / {β}_{A}^{′} + \\ ( n / ( m + n ) ) ( {K}_{B}^{′} - ( ( m + n ) / n ) \cdot {C}_{B} ) / {β}_{B}^{′} \}\end{matrix} & ( 107 )\end{matrix}$$

then, from formulae (6) and (7), the following formulae are available:

$$\begin{matrix}\begin{matrix}{C}_{A} = [ {β}_{A} {β}_{A}^{′} \{ {β}_{B} Ln ( τ ) - {β}_{B}^{′} Ln ( {τ}^{′} ) \} / ( {β}_{A} {β}_{B}^{′} - {β}_{B} {β}_{A}^{′} ) ] - \\ \{ n {β}_{A} {β}_{A}^{′} ( {K}_{B} - {K}_{B}^{′} ) + m ( {β}_{B} {β}_{A}^{′} {K}_{A} - {β}_{A} {β}_{B}^{′} {K}_{A}^{′} ) \} / \\ ( m + n ) ( {β}_{A} {β}_{B}^{′} - {β}_{B} {β}_{A}^{′} )\end{matrix} & ( 108 ) \\ \begin{matrix}{C}_{B} = [ {β}_{B} {β}_{B}^{′} \{ {β}_{A} Ln ( τ ) - {β}_{A}^{′} Ln ( {τ}^{′} ) \} / ( {β}_{B} {β}_{A}^{′} - {β}_{A} {β}_{B}^{′} ) ] - \\ \{ m {β}_{B} {β}_{B}^{′} ( {K}_{A} - {K}_{A}^{′} ) + n ( {β}_{A} {β}_{B}^{′} {K}_{B} - {β}_{B} {β}_{A}^{′} {K}_{B}^{′} ) \} / \\ ( m + n ) ( {β}_{B} {β}_{A}^{′} - {β}_{A} {β}_{B}^{′} )\end{matrix} \\ \text{where,} \\ \begin{matrix}{K}_{A} / {K}_{B} = {β}_{A} / {β}_{B} ( or {K}_{A} \cdot {β}_{B} = {K}_{B} \cdot {β}_{A} ) \\ {K}_{A}^{′} / {K}_{B}^{′} = {β}_{A}^{′} / {β}_{B}^{′} ( or {K}_{A}^{′} \cdot {β}_{B}^{′} = {K}_{B}^{′} \cdot {β}_{A}^{′} )\end{matrix} & ( 109 )\end{matrix}$$

are valid, and from formulae (108) and (109), the following formulae are available:

C_{A}={K_{A}′·K_{B}·β_{A}·Ln(τ)−K_{A}·K_{B}′·β_{A}′·Ln(τ′)}/(K_{A}·K_{B}′−K_{A}′·K_{B})−(m+n)·K_{A}·K_{A}′·(K_{B}−K_{B}′)/(m+n)·(K_{A}·K_{B}′−K_{A}′·K_{B})

C_{B}={K_{A}·K_{B}′·β_{B}·Ln(τ)−K_{A}′·K_{B}·β_{B}′·Ln(τ′)}/(K_{A}′·K_{B}−K_{A}·K_{B}′)−(m+n)·K_{B}·K_{B}′·(K_{A}−K_{A}′)/(m+n)·(K_{A}′·K_{B}−K_{A}·K_{B}′)

Therefore, the following concentration calculating formulae are available:

C_{A}={K_{A}′·K_{B}·β_{A}·Ln(τ)−K_{A}·K_{B}′·β_{A}′·Ln(τ′)−K_{A}·K_{A}′(K_{B}−K_{B}′)}/(K_{A}·K_{B}′−K_{A}′·K_{B}) (110)

C_{B}={K_{A}·K_{B}′β_{B}·Ln(τ)−K_{A}′·K_{B}·β_{B}′·Ln(τ′)−K_{B}·K_{B}′(K_{A}−K_{A}′)}/(K_{A}′·K_{B}−K_{A}·K_{B}′) (111)

(Description of character)

C_{A}: concentration of constituent A contained in the binary chemical solution

C_{B}: concentration of constituent B contained in the binary chemical solution

τ: transmission coefficient (or output of light receiving system) of the first light (wavelength: 1.65 μm) for the binary chemical solution

τ′: transmission coefficient (or output of light receiving system) of the second light (wavelength: 1.45 μm) for the binary chemical solution

τ_{A}: transmission coefficient of the first light for the single-constituent chemical solution A [concentration: ((m+n)/m)·C_{A}]

τ_{B}: transmission coefficient of the first light for the single-constituent chemical solution B [concentration: ((m+n)/n)·C_{B}]

τ_{A}′: transmission coefficient of the second light for the single-constituent chemical solution A [concentration: ((m+n)/m)·C_{A}]

τ_{B}′: transmission coefficient of the second light for the single-constituent chemical solution B [concentration: ((m+n)/n)·C_{B}]

K_{A}, K_{B}, K_{A}′, K_{B}′, β_{A}, β_{B}, β_{A}′ and β_{B}′

:constants of concentration calculating formula (formula (2)) of single-constituent chemical solutions A and B for the light of each wavelength

As described above, the coefficients K and β are intrinsic to each chemical solution for the light of a particular wavelength band, and these coefficients K and β are functions of temperature (formulae (3) and (4)). The constants in formulae are previously determined for individual chemical solutions and stored in the microcomputer 45 provided in the control section 40, or determined prior to measurement by calibrating circuit 49 provided in the control section 40 in accordance with a prescribed calibrating procedure.

Therefore, the liquid concentration detecting apparatus 1 detected the temperature of the chemical solution flowing in the cell 9 by using the liquid temperature sensor 98, and calculates the coefficients K and β by using the microcomputer 45. Then, the microcomputer calculates the concentrations of constituents A and B contained in a mixed chemical solution in accordance with formulae (110) and (111), using the PD outputs against the light from the first light source 4A and form the second light source 6A respectively.

In the concentration calculating technique 2 as well, as required, it is of course possible to previously set a K-value and a β-value as constants in the microcomputer 45, and perform calculation by means of these values. In this case, measurement of temperature of the chemical solution flowing through the cell 9 may be omitted.

According to this embodiment, the liquid concentration information thus calculated by the microcomputer 45 is converted into a display signal by a display circuit 46, and the concentration information is displayed on a display section 47 such as an LCD panel. Also, the information about the liquid concentration as calculated by the microcomputer 45 may be transmitted to a computer communicably connected to the liquid concentration detecting apparatus 1, and the concentration information may be displayed on a display (not shown) of this computer. Furthermore, the concentration information can be recorded (typed or plotted) on a paper as an output on a printer connected to the liquid concentration detecting apparatus 1, or to a computer communicable with the liquid concentration detecting apparatus 1.

As required, it is possible to provide an alarm. In this embodiment, an alarm setting circuit 48 making a setting so as to issue an alarm when a prescribed concentration is reached is provided in the control section 40.

The liquid concentration detecting apparatus 1 of this embodiment further comprises a liquid leakage sensor 16 in the detecting section 2. Output of the leakage sensor 16 is detected by a leakage detecting circuit 50 in the control section 40. Upon receipt thereof, the microcomputer 45 notifies the user of a leakage of the liquid in a display section 47, or on the display of the computer connected to the liquid concentration detecting apparatus 1, or by an audio-alarm. As the leakage sensor 16, a sensor made by Toyoko Kagaku Co., Model RS-1000 is suitably applicable as the leakage sensor 16.

In this embodiment, the detecting section 2 is housed in an enclosure having a dust-preventing mechanism and water-proof mechanism, and separated from the control section 40.

In the arrangement configuration of the first projecting section 4 and the second projecting section 6, the light source having a central wavelength of 1.65 μm and 1.45 μm may be arbitrarily positioned as the first light source 4A or the second light source 6A.

As described above, the liquid concentration detecting apparatus 1 of this embodiment can detect the concentration of constituents of a binary chemical solution inline in a real-time manner, by connecting the apparatus 1 to an etching solution feed source or a cleaning apparatus.

It is possible to detect the concentration of constituents contained in an arbitrary binary mixed chemical solution such as HF—H₂O₂, HF—HCl, HF—NH₄F, HF—HNO₃, NH₃—H₂O₂, H₂SO₄—H₂O₂, H₂SO₄—HCl, H₃PO₄—HNO₃, HCl—H₂O₂, KOH—H₂O₂ or HCl—FeCl₃.

Temperature control mechanism

The temperature control mechanism provided in the liquid concentration detecting apparatus 1 of this embodiment will now be described.

In order to achieve a satisfactory operation of the liquid concentration detecting apparatus 1 of this embodiment, it is very important to ensure temperature stability of the detecting section 2. For example, a use environment of the liquid concentration detecting apparatus 1 of this embodiment such as an etching line can have a temperature within a range of from 10 to 40° C. Suitable usage temperatures range from 20 to 30° C. as described later. In order to always ensure high-accuracy detection of concentration without being affected by a change in environmental temperature, or by heat-generating component parts of the apparatus 1 itself, a temperature control mechanism as described below is provided in the liquid concentration detecting apparatus 1 of this embodiment.

For example, the laser diode (LD) used as the light source (first light source 4A and second light source 6A) in this embodiment generates heat while turn-on state is maintained. If the state of a high temperature (even over 60° C. for an LD) is kept as a result of self-generation of heat, the service life thereof is seriously reduced. In general, for a light source, the amount of emitted light varies according as the temperature varies. In the case of the LD used in this embodiment, the amount of emitted light decreases along with an increase in temperature. The temperature characteristic of these light sources possibly cause a measurement error.

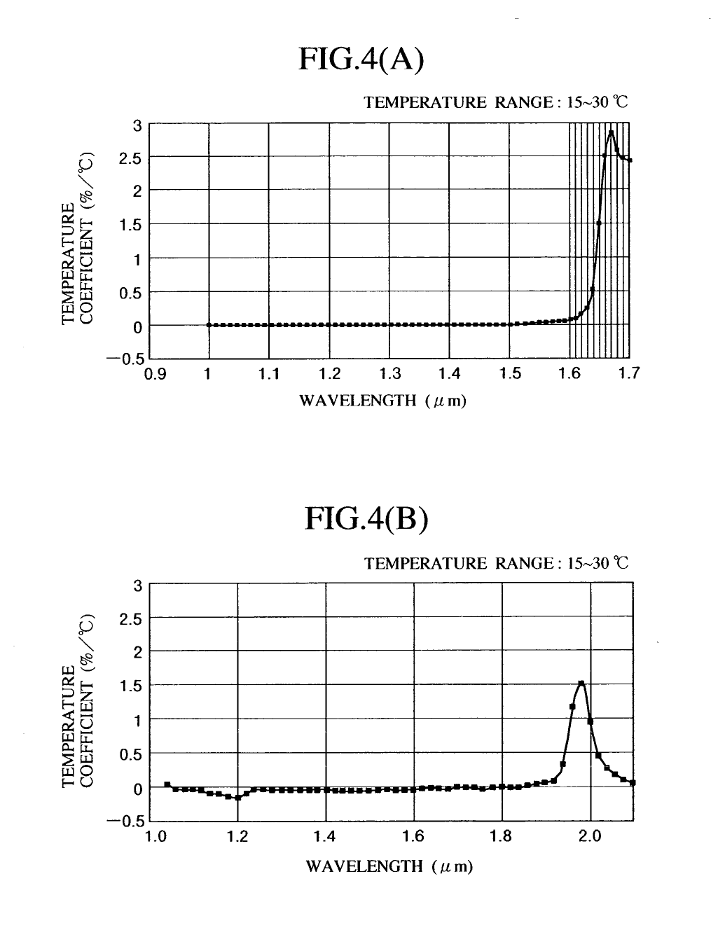

FIG. 4 illustrates sensitivity-temperature characteristic of two kinds of photodiode (PD). FIG. 4A shows temperature characteristic of the Model G5832-01 made by Hamamatsu Photonics Co., an example of photodiode within a temperature range of from 15 to 35° C.; and FIG. 4B shows temperature characteristic of the Model G5851-01 made by the same company within the same temperature range.

In the case of the photodiode (Model: G5832-01) of which the result is shown in FIG. 4A, the sensitivity-temperature coefficient is constant within a wavelength region of substantially up to 1.6 μm. For wavelengths of over 1.6 μm, however, the sensitivity-temperature coefficient varies largely. In the case of FIG. 4B (Model: G5851-01), the sensitivity-temperature coefficient is constant within a wavelength region of substantially up to 1.9 μm, and the sensitivity-temperature characteristic varies for a wavelength of over 1.9 μm. Even within a wavelength region of up to 1.9 μm, the sensitivity-temperature coefficient is not 0, but has some temperature characteristic.

A photodiode has temperature characteristic to some extent, although not so remarkable as a laser diode as described above. The sensitivity-temperature coefficient considerably varies with the wavelength region for some models. The temperature characteristic of this light detector 11A (reference light detector 13A) also possibly causes a measurement error.

Temperature characteristic of the beam splitter 8 will now be described. For example, the non-polarization cube beam splitter (made by Sigma Koki Co.) used as a beam splitter 8 in this embodiment is prepared by coating a slant of a 45° right-angle prism of quartz glass (BK7, class A) with a metal film or a dielectric multi-layer film, and bonding the slants as described above. In a beam splitter having such a configuration, the quartz glass (BK7) has no temperature characteristic, whereas the metal and dielectric used in the reflecting film have temperature characteristic. Thus, the division ratio of transmitting light/reflected light varies with a change in temperature.

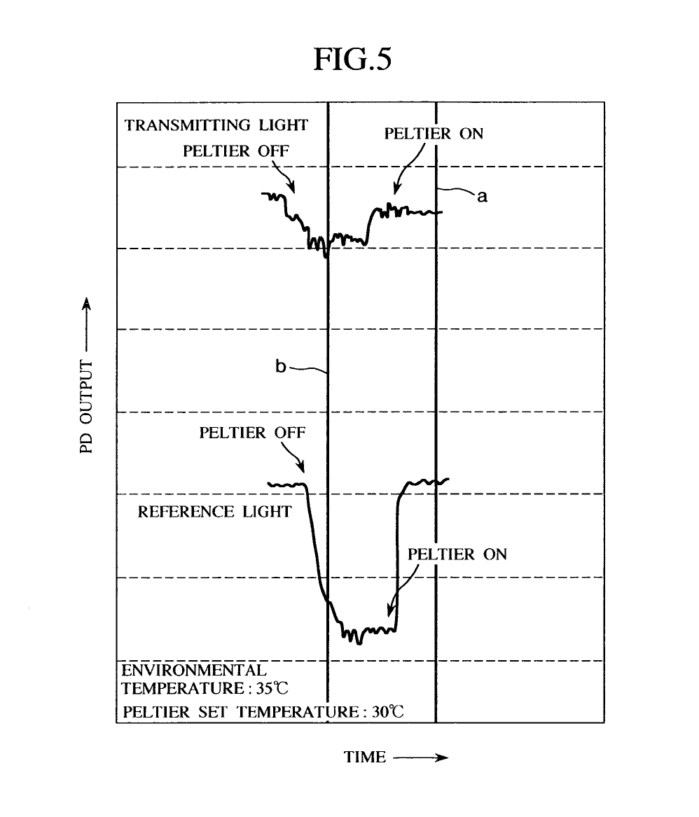

FIG. 5 shows values of output (mV) of the light detector 11A and the reference light detector 13A in cases with and without temperature control of the beam splitter 8 by the temperature control mechanism described later. FIG. 5 illustrates the output resulting from a feedback resistance of 6.4 kΩ of the transmitting light PD amplifier 14a and the reference light PD amplifier 14b, a control target temperature of 30° C., and an environmental temperature of 35° C. when providing an absorbing filter on the optical path from the beam splitter 8 to the transmitting light receiving section 11 in place of the cell 9 and a sample, and using the first light source 4A (1.65 μm) as the light source. This experiment was carried out in a state in which temperature control was applied to an optical system component parts (including PD amplifying circuit board 14) other than the beam splitter 8.

According to the result of this experiment, by turning off temperature control using a Peltier device described later which is temperature control means, the transmitting light PD output decreases by about 2 to 3 mV, and the reference light PD output decreases by about 9 mV. That is, a change in temperature causes a change in the light division ratio by the beam splitter 8, and the ratio (transmitting light PD output/reference light PD output) varies largely. For example, at point “a” where temperature control with a Peltier device is applied, this ratio is:

$$\begin{matrix}\begin{matrix}\text{(Transmitting light PD output} / \\ \text{reference light PD output)}\end{matrix} = 1682.7 / 1266.5 \\ = 1.3286\end{matrix}$$

and at point “b” where no temperature control is applied:

$$\begin{matrix}\begin{matrix}\text{(Transmitting light PD output} / \\ \text{reference light PD output)}\end{matrix} = 1680.7 / 1257.5 \\ = 1.3365\end{matrix}$$

If the reference value Q of PD output (reference light PD output at 25° C.) is assumed to be 1260 (mV), the PD output under temperature control (value after correction with the reference value Q) is:

PD output with temperature control=1674 mV

PD output without temperature control=1684 mV

There is thus a large variation of 10 mV in PD output between the both. This variation of PD output is in danger of forming an important factor causing an error.

It is assumed that the measuring accuracy is a value obtained by dividing the variation of the PD output (mV) by sensitivity [the amount of change in PD output (mV) per chemical solution concentration (PD output (mV))/difference in concentration (wt. %)] as in the following formula:

$$\text{Measuring accuracy} = \text{Variation of} \text{PD} \text{output} / \text{(variation of PD output} / \text{difference in concentration)} \text{[wt. \%]}$$

It is required to measure the concentrations of individual constituents at a measuring accuracy of ±0.01 wt % when the concentration of a constituent to be measured in the chemical solution is within a range of from 0 to 1 wt. % (low-concentration solution); ±0.05 wt. % when the concentration is within a range of from 1 to 10 wt. % (medium-concentration solution); and ±0.1 wt. % when the concentration of at least 10 wt. % (high-concentration solution). In this case, when the transmitting light PD amplifier 14a and the reference light PD amplifier 14b are assumed to have a feedback resistance of 6.4 kΩ, it is necessary to inhibit the PD output to ±3 mV. Therefor, the above-mentioned variation of 10 mV in PD output owing to the temperature characteristic of the beam splitter 8 possibly poses a problem on the measuring accuracy.

According to a study carried out by the present inventor, the beam splitter 8 of this embodiment does not exhibit temperature characteristic for the light having a central wavelength of 1.45 μm which is used as the second light source 6A in this embodiment. This is considered attributable to the fact that the temperature characteristic of the beam splitter 8 of this embodiment, particularly of the reflecting film thereof is wavelength-dependent.

Further, according to a study carried out by the present inventor, it was found that the PD amplifiers 14a and 14b show also temperature characteristic. This temperature characteristic is considered to vary with performance of the component parts contained in the amplifying circuit and the manner of building the circuit. Without temperature control, the ratio (transmitting light PD output/reference light PD output) possibly varies considerably. This tendency depends also upon the deviation between the transmitting light PD amplifier 14a and the reference light PD output.

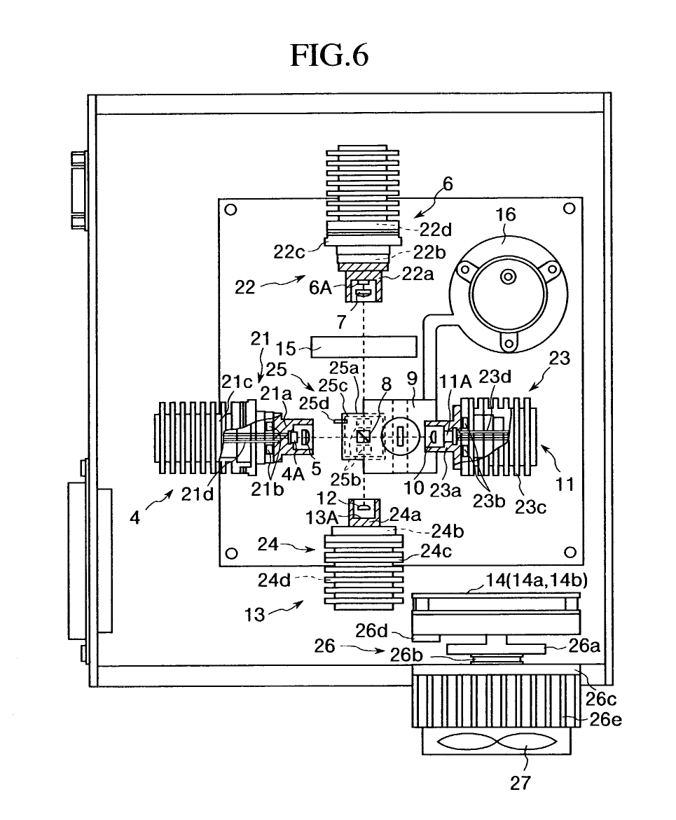

For the purpose of preventing a measuring error caused by the temperature characteristic of the above-mentioned optical system component parts (including the PD amplifiers 14a and 14b), the liquid concentration detecting apparatus 1 of this embodiment has a temperature control mechanism. FIG. 6 illustrates a typical schematic view of the detecting section 2 having the temperature control mechanism.

In the temperature control mechanism shown in FIG. 6, the first projecting section 4, the second projecting section 6, the transmitting light receiving section 11, the reference light receiving section 13, the beam splitter 8, and the PD amplifying circuit board 14 have thermo-modules 21, 22, 23, 24, 25 and 26 provided with a heat conducting member, temperature control means, heat releasing means and temperature detecting means, respectively.

The first projecting section 4 and the second projecting section 6 will first be described. In this embodiment, the thermo-modules 21 and 22 provided in the first projecting section 4 and the second projecting section 6, respectively, have the same configuration. Only the thermo-module 21 of the first projecting section 4 is therefore illustrated in detail in FIG. 6.

The first light source 4A of the first projecting section 4 (made by NTT Electronics Co.: Model NKL1601TOB) and the second light source 6A of the second projecting section 6 (made by NTT Electronics Co.: Model NKL1402TOB) (both are CAN type LDs) are provided in the heat conducting cases 21a and 22a serving as heat conducting members, respectively, and the bottoms (surfaces opposite to the light emitting surfaces) of the laser diodes 4A and 6A are fixed to, and brought into contact with, the heat conducting cases 21a and 22a. Cooling plate sides of the Peltier devices 21b and 22b serving as temperature control means are in contact with the bottoms of the heat conducting cases 21a and 22a. The heat conducting cases 21a and 22a are secured to heat sinks 21c and 22c serving as heat releasing means to release heat via the Peltier devices. Furthermore, thermistors 21d and 22d serving as temperature detecting means are provided in the heat conducting cases 21a and 22a so as to permit detection of temperature of the laser diodes 4A and 6A.

At portions requiring bonding such as attachment of a thermistor, a heat-releasing adhesive (for example, Cemedyne Co.: two-liquid cold hardening type epoxy adhesive, SG-EPO Series, EP-007) can suitably be used. A heat-releasing grease (for example, Mizutani Denki Kogyo Co.: Commercial product name: HEATSINKER) can be used on connecting surfaces between the bottoms of the laser diodes 4A and 6A and the heat conducting cases 21a and 22a.

Thermo-modules 23 and 24 having a heat conducting member, temperature control means, heat releasing means and temperature detecting means are provided also in the transmitting light receiving section 11 and the reference light receiving section 13, respectively. In this embodiment, the thermo-modules 23 and 24 of the transmitting light receiving section 11 and the reference light receiving section 13 have the same configurations. FIG. 6 therefore shows only the thermo-module 23 of the reference light receiving section 11 is illustrated in detail.

The thermo-modules 23 and 24 of the transmitting light receiving section 11 and the reference light receiving section, respectively, have substantially the same configuration as that of the above-mentioned thermo-modules 21 and 22 of the first and second projecting sections 4 and 6. The photodiodes serving as the light detector 11A and the reference light detector 13A are built in the heat conducting cases 23a and 24a serving as heat conducting members, respectively. Bottoms of the photodiodes 11A and 13A are secured to the heat conducting cases 23a and 24a in contact therewith. Cooling plate sides of the Peltier devices 23b and 24a serving as temperature control means are in contact with the bottoms of the head conducting cases 23a and 24a. The heat conducting cases 23a and 24a are fixed to the heat sinks 23c and 24c serving as heat releasing means via these Peltier devices. Furthermore, thermistors 23d and 24d serving as temperature detecting means are provided in the heat conducting cases 23a and 24a so as to permit detection of temperature of the photodiodes 11A and 13A.

Alternately, for the light detector 11A and the reference light detector 13A of the transmitting light receiving section 11 and the reference light receiving section 13, a photodiode incorporating a Peltier device serving as temperature control means (made by Hamamatsu Photonics Co.: Model G5851-11) is commercially available, and this photodiode may be attached to the heat sinks 23a and 24a serving as heat releasing means.

According to this embodiment, temperature control is effected by providing a thermo-module 25 also in the beam splitter 8. More specifically, the beam splitter 8 is fixed on a heat conducting stand 25a serving as the heat conducting member in contact with the beam splitter 8. A cooling plate side of the Peltier device 25 serving as temperature control means is in contact with the bottom of this heat conducting stand 25a, which is secured to an attachment stand 25c functioning also as heat releasing means via the Peltier device 25b. A thermistor 25c serving as temperature detecting means for detecting the temperature of the beam splitter 8 is provided on the heat conducting stand 25a.

In this embodiment, furthermore, the apparatus 1 has a thermo-module 26 conducting temperature control of the PD amplifying substrate 14 formed integrally with the transmitting light PD amplifier 14a and the reference light PD amplifier 14b. That is, the PD amplifying circuit board 14 is attached to the heat conducting plate 26a serving as a heat conducting member. The back of the heat conducting plate 26a, that is, the opposite side to the circuit board is in contact with the cooling plate side of the Peltier device 26b serving as temperature control means. The heat conducting plate 26a is connected to the heat releasing plate 26c having a radiation fin 26e exposed to outside the liquid concentration detecting apparatus 1 as heat releasing means, via the Peltier device 26b. A fan 27 for accelerating heat release is provided so as to be exposed to outside the apparatus 1. A thermistor 26d serving as temperature detecting means detecting the temperature of the PD amplifying circuit board 14 is provided on the heat conducting plate 26a.

The thermistors 21d to 26d serving as temperature detecting means and the Peltier devices 21b to 26b serving as temperature control means provided for the first projecting section 4, the second projenting section 6, the transmitting light receiving section 11, the reference light receiving section 13, the beam splitter 8 and the PD amplifying circuit board 14, respectively, are electrically connected to an automatic temperature control circuit (ATC) 43 provided in the control section 40, to control power supply to the individual Peltier devices 21b to 26b and driving of the fan 27 in response to the output of each thermistor, and to adjust the temperature. As the automatic temperature control circuit 43, for example, the MPT Series made by Wavelength Electronics Co. can suitably be used. An automatic temperature control circuit (ATC) can be provided for each of the optical parts. However, because only the first and second projecting sections 4, 6 are heat-generating parts from among the optical parts, it is possible to adopt a configuration in which an ATC 43 for the projecting sections 4 and 6, and another ATC 43b for the other optical components including the transmitting light receiving section 11, the reference light receiving section 13, the beam splitter 8 and the PD amplifying circuit board 14 are provided.

In the liquid concentration detecting apparatus 1 of this embodiment, the aforementioned temperature control mechanism controls temperature within a range of from 10 to 40° C. More preferably, temperature is controlled within a range of temperature at which the optical parts hardly become dewy and which is close to the room temperature. That is, temperature should preferably be controlled within a range of from 20 to 30° C., or more preferably, to 25° C.

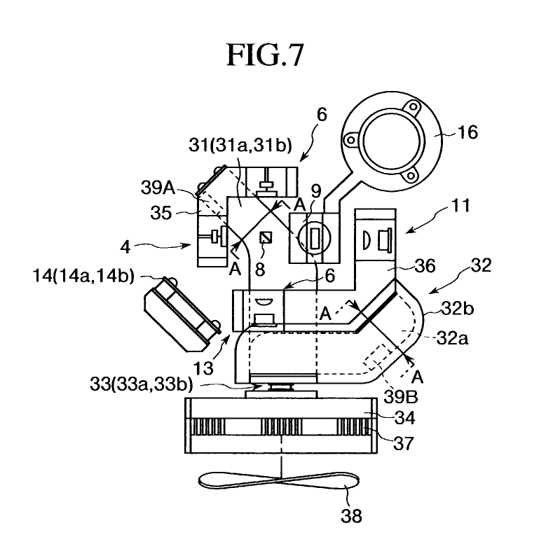

Another example for arrangement of the temperature control mechanism according to the present invention will now be described with reference to FIG. 7.

In the temperature control mechanism described with reference to FIG. 6, the independent thermo-modules 21 to 26, i.e., the heat conducting members 21a to 26a, the temperature control means 21b to 26b, the heat releasing means 21c to 26c and the temperature detecting means 21d to 26d are provided for the first projecting section 4, the second projecting section 6, the transmitting light receiving section 11, the reference light receiving section 13, the beam splitter 8 and the PD amplifying substrate 14. On the other hand, in the temperature control mechanism shown in FIG. 7, thermo-modules are not provided for each of optical components (including the PD amplifying circuit board 14), but several members in groups are connected to the temperature control means and heat releasing means via the heat conducting member.

More specifically, in the embodiment shown in FIG. 7, the first projecting section 4 and the second projecting section 6 are provided in heat-transfer fixing means 35 connected to a first heat conducting member 31, and the first and second projecting sections 4 and 6 are arranged so as to permit heat transfer to the first heat conducting member 31. On the other hand, the transmitting light receiving section 11 and the reference light receiving section 13 are provided in heat-transfer fixing means 36 connected to a second heat conducting member 32 so that the transmitting light receiving section 11 and the reference light receiving section 13 can transfer heat to the second heat conducting member 32. In this embodiment, the beam splitter 8 and the PD amplifying circuit board 14 are fixed to a heat-transfer fixing means (not shown) connected to the second heat conducting member 32 in a manner permitting heat transfer, so as to permit heat transfer to the second heat conducting member 32.

The first heat conducting member 31 and the second heat conducting member 32 are connected to the cooling plate sides of the Peltier devices 33a and 33b serving as temperature control means, respectively. The Peltier devices 33a and 33b are connected to the heat radiation plate 34 as heat releasing means having a head radiation fin 37 provided so as to be exposed to outside the liquid concentration detecting apparatus 1, and furthermore, a fan 38 is provided so as to be exposed to outside the apparatus 1 so as to enhance the heat releasing effect.

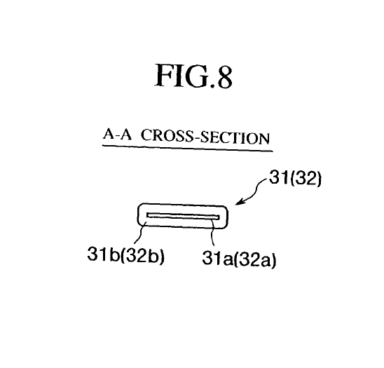

The first and second heat conducting members 31 and 32 comprise, as shown in FIG. 8, a first heat conducting plate 31a and a second heat conducting plate 32a serving as heat conducting members coated with heat-insulating materials 31b and 32b, respectively, in which the coating with heat-insulating materials 31b and 32b is removed only at portions in contact with the fixing means of the first projecting section 4, the second projecting section 6, the transmitting light receiving section 11, the reference light receiving section 13, the beam splitter 8 and the PD amplifying circuit board 14.

Thermistors 39A and 39B serving to detect temperature are provided to permit detection of temperature of the first and second heat conducting members 31 and 32, respectively. These thermistors 39A and 39B and the Peltier devices 33a and 33b serving to adjust temperature are electrically connected to automatic temperature control circuits (ATC) 43a and 43b (FIG. 2) provided in the control section 40. Temperature adjustment is accomplished through control of supply of electricity to the Peltier devices 33a and 33b and driving of the fan 38 in response to the output of each thermistor.

Temperature control of the optical components can be satisfactorily carried out also in the configuration of the temperature control mechanism as described above. Because the number of Peltier devices serving as temperature control means can be reduced, the invention provides advantages of a simpler temperature control operations and cost reduction.

As in the embodiment shown in FIG. 7, when the Peltier devices are used commonly to several optical components by using the heat conducting members 31 and 32 having the heat conducting plates 31a and 32a, it is desirable to provide separately the first heat conducting plate 31a for at least the projecting section (i.e., the first projecting section 4 and the second projecting section 6 in this embodiment) and the second heat conducting plate 32a for the other optical components (including the PD amplifying substrate 14). Because only the first and second light sources 4A and 6A generate heat from among the components in the optical system 3, it is necessary to use a larger heat capacity of the first heat conducting plate 31a than that of the heat conducting plate for the other optical components. As a result, temperature control performance equivalent to that of the temperature control mechanism shown in FIG. 6 can suitably be displayed.

By covering the heat conducting plates 31a and 32a with heat-insulating materials 31b and 32b, it is possible to prevent heat from the LD which is a heat-generating member from affecting the other means, and to isolate them from the effect of an external environmental temperature.

Temperature control of the optical components (including the PD amplifying circuit board) has been described above. The present invention is not however limited to provision of all these temperature control means. For example, when a part without temperature characteristic, or acceptably low in the temperature characteristic is available, temperature control for such a part can be omitted.

As described above, by applying temperature control to the optical system 3 comprising the first and second projecting sections 4 and 6, the transmitting light and reference light receiving sections 11 and 13, the beam splitter 8 and the PD amplifying substrate 14, it is possible to prevent occurrence of a measuring error caused by temperature characteristic of the individual components as described above. Therefore, when the concentration of a constituent to be measured in the chemical solution is within a range of from 0 to 1 wt. % (low-concentration solution), the concentration can be detected with a high reliability at a high accuracy of ±0.01 wt. % for each constituent, ±0.05 wt. % for a concentration range of from 1 to 10 wt. % (medium-concentration solution), and ±0. 1 wt. % for a concentration range of over 10 wt. % (high-concentration solution).

Embodiment 2

The liquid concentration detecting apparatus of this embodiment has substantially the same configuration as that of the liquid concentration detecting apparatus 1 of embodiment 1, except only for the configuration of projecting sections. Therefor, parts having the same configuration and functions are assigned the same reference numerals, and omitting a detailed description of the parts here.

In this embodiment, a light source emitting light having a central wavelength within a range of from 1.9 to 2.05 μm in a near infrared region is also used. For that wavelength region of light, the absorbance largely varies with the difference in concentration between chemical solution constituents contained in the chemical solution to be measured. More specifically, a laser diode (made by NTT Electronics Co.: Model KELD1901CCA/TOA) having a central wavelength of emitted light of 2.0±0.05 μm, and a wavelength region of from 1.99 to 2.01 μm at 50% of the maximum amount of light (hereinafter simply refer to as the “light source of the central wavelength of 2.0 μm) is used.

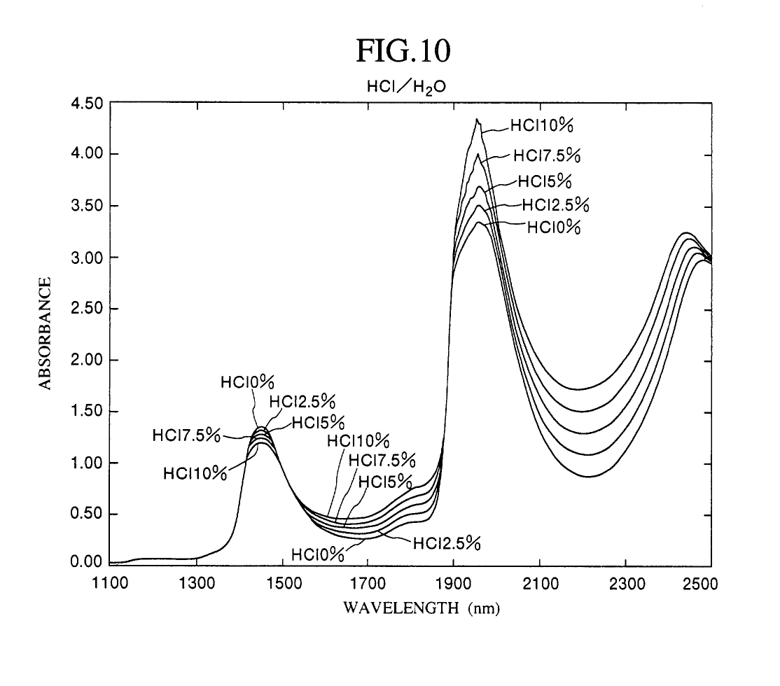

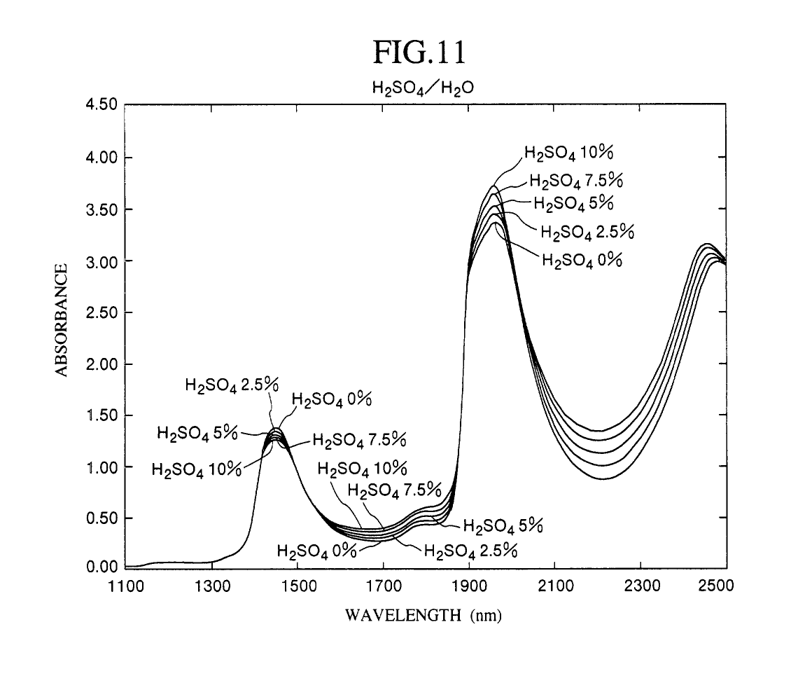

As is clear from FIGS. 10 and 11, in the near infrared-ray absorption spectra by various chemical solutions, the absorbance near a wavelength of 2.0 μm considerably varies with the difference in concentration of the chemical solutions. The difference in light absorption near a range of from 1.9 μm to 2.0 μm is considered to be based on the sum (synthesis) of light absorption attributable to oxygen-hydrogen binding group of water (synthesis of overtone of O—H stretching vibration and overtone of O—H bending vibration) and light absorption by ionic hydration in the aqueous solution as described above. The degree of change in absorbance caused by the difference in the solution concentration relative to the light within this wavelength band is different from the degree of change relative to the light having a central wavelength of 1.65 μm used as the first light source 4A.

First, a light source having a central wavelength of 2.0 μm can be used in place of the light source having a central wavelength of 1.65 μm used as the first light source 4A in the liquid concentration detecting apparatus 1 of embodiment 1.

In this case, calculation of concentrations (C_{A}, C_{B}) of the individual constituents (constituents A and B) in a binary mixed chemical solution can be accomplished by the same method as the concentration calculating technique 1 or 2 described in embodiment 1. That is, all the above descriptions concerning each of the concentration calculating techniques 1 and 2 in embodiment 1 are applicable, by reading the statement regarding the light source having a central wavelength of 1.65 μm (as the first light source 4A) as if the statement were for the light source having a central wavelength of 2.0 μm. However, V_{1.65} used in the calculating formula should be changed into V_{2 0} (PD output in a case where the light having a central wavelength of 2.0 μm is irradiated onto the binary mixed chemical solution). The description in embodiment 1 is therefore valid also for the present case.

The light source having a central wavelength of 2.0 μm can be also used in place of the light source having a central wavelength of 1.45 μm used as the second light source 6A in the liquid concentration detecting apparatus of embodiment 1.

In this case, calculation of concentrations (C_{A}, C_{B}) of the individual constituents (constituents A and B) of the binary mixed chemical solution can be accomplished as follows in the same manner in principle as in the concentration calculating techniques 1 and 2 described embodiment 1.

Concentration calculating technique 1

First, a concentration calculating technique based on the same principle as in the concentration calculating technique 1 described above in embodiment 1 will be explained. This concentration calculating technique is an approximate method which is applicable in response to a required measuring accuracy, constituents of the chemical solution to be measured and the like.

Consideration will now be made about a case where, concentrations C_{A} (wt. %) and C_{B} (wt. %) in a mixed chemical solution of constituents A and B (such as hydrofluoric acid and nitric acid) contained in the chemical solution to be measured such as an etching solution is to be determined. If additivity is valid for concentrations of constituents A and B in the mixed chemical solution, i.e., on the assumption that a new constituent is not formed through reaction between constituents A and B, the total concentration of constituents A and B in the mixed chemical solution would be:

C=C_{A}+C_{B} (44)

(i) Absorption of the light having a wavelength band of 1.65 μm by the binary mixed chemical solution is considered as follows. On the assumption that a mixed chemical solution is obtained by mixing single-constituent chemical solutions A and B having concentrations C_{A(single 1 65)} and C_{B(single 1 65)}, respectively, at mixing ratios X (wt/wt. %) and Y (wt/wt. %), then,

C_{A}=C_{A(single 1.65)}·X/100 (45)

C_{B}=C_{B(single 1 65)}·Y/100 (46)

X+Y=100 (47)

are valid, and there is available from formula (44):

C_{A(single 1.65)}·X/100+C_{B(single 1.65)}·Y/100=C_{A}+C_{B} (48)

Because formula (2) is valid for all the constituents to be measured in the chemical solution, as described above, concentrations C_{A(single} 1.65) and C_{B(single 1.65)} of the single-constituent chemical solutions A and B relative to the light having a central wavelength of 1.65 μm are expressed by:

C_{A(single 1.65)}=K_{AI}−β_{AI} ln(V_{AI}) (49)

C_{B(single 1 65)}=K_{BI}−β_{BI} ln(V_{BI}) (50)

where,

V_{AI}: PD output relative to the light having a central wavelength of 1.65 μm exhibited when constituent A is a single constituent; and

V_{BI}: PD output relative to the light having a central wavelength of 1.65 μm exhibited when constituent B is a single constituent.

When this relationship is assumed to be approximately represented by:

V_{AI}=V_{BI}=V_{1.65}

where,

V_{1 65}: PD output relative to the light having a central wavelength of 1.65 μm exhibited by the mixed chemical solution),

then, formula (48) would be rewritten, from the relationship represented by formulae (49) and (50), by:

(K_{AI}−β_{AI} ln(V_{1.65}))X+(K_{BI}−β_{BI} ln(V_{1.65}))Y=100(C_{A}+C_{B}) (51)

(ii) A similar concept is introduced about absorption of the light having a central wavelength of 2.0 μm by a binary mixed chemical solution. That is, a mixed chemical solution is assumed to be obtained by mixing the single-constituent chemical solutions A and B having concentrations C_{A(single 2 0)} and C_{B(single 2.0), respectively, at mixing ratios X (wt/wt. %) and Y (wt/wt. %), then:}

C_{A}=C_{A(single} 2.0)·X/100 (52)

C_{B}=C_{B(single 2.0)}·Y/100 (53)

X+Y=100 (54)

are valid, and from formula (44):

C_{A(single 2 0)}·X/100+C_{B(single 2 0)}·Y/100=C_{A}+C_{B} (55)

is obtained.

Since formula (2) is valid for all the constituents to be measured in the chemical solution, as described above, concentrations C_{A(single 2 0)} and C_{B(single 2 0)} of the single-constituent chemical solutions A and B relative to the light having a central wavelength of 2.0 μm can be expressed by:

C_{A(single 2 0)}=K_{AII}−β_{AII} ln(V_{AII}) (56)

C_{B(single 2 0)}K_{BII}−β_{BII} ln(V_{BII}) (57)

where,

V_{AII}: PD output relative to the light having a central wavelength of 2.0 μm exhibited when constituent A is a single constituent; and

V_{BII}: PD output relative to the light having a central wavelength of 2.0 μm exhibited when constituent B is a single constituent.

When this relationship is assumed to be approximately represented by:

V_{AII}=V_{BII}=V_{2.0}

where,

V_{2.0}: PD output relative to the light having a central wavelength of 2.0 μm exhibited by the mixed chemical solution, then, formula (55) would be rewritten, from the relationship represented by formulae (56) and (57), by:

(K_{AII}−β_{AII} ln(V_{2 0}))X+(K_{BII}−β_{BII} ln(V_{2 0}))Y=100(C_{A}+C_{B}) (58)

The above-mentioned V_{1 65} and V_{2.0} are PD output values obtained by measurement. Coefficients K_{AI}, K_{BI}, β_{AI} and β_{BI} are intrinsic to the individual chemical solutions relative to the light having a central wavelength of 1.65 μm. Coefficients K_{AII}, K_{BII}, β_{AII} and β_{BII} are intrinsic to the individual chemical solutions relative to the light having a central wavelength of 2.0 μm.

As has been described in embodiment 1, these coefficients K and β are functions of temperature, and are predetermined for the individual chemical solutions, or determined, prior to measurement, in accordance with a prescribed calibrating procedure described later.

C_{A} and C_{B} can therefore be calculated by deriving X and Y from the relationship expressed by formulae (51), (58) and (47) (or formula (54)) through detection of temperature and PD output of the chemical solution, and eliminating X and Y from formulae:

C_{A}=(K_{AI}−β_{AI} ln(V_{1 65}))·X/100

C_{B}=(K_{BI}−β_{BI} ln(V_{1.65}))·Y/100

or,

C_{A}=(K_{AII}−β_{AII} ln(V_{2 0}))·X/100

C_{B}=(K_{BII}−β_{BII} ln(V_{2.0}))·Y/100

As in embodiment 1, as required, it is possible to previously set a K-value and a β-value as constants in the microcomputer 45, and performing calculation by use thereof. In this case, measurement of temperature of the chemical solution flowing through the cell 9 can be omitted.

Concentration calculating technique 2

A calculating method based on a principle similar to that of the concentration calculating technique 2 described above in embodiment 1 will now be described. This method is applicable in cases where a more accurate calculation of concentration is required.

In the concentration calculating technique 2, concentrations of individual constituents to be measured of a mixed chemical solution are calculated by use of a convergence calculating technique based on a principle similar to that in embodiment 1. In this embodiment, however, the sign of the P-values is kept constant in the concentration calculating formula (in compliance with formula (2)) for the individual constituents of the chemical solution to be measured, relative to absorption of the light having a central wavelength of 1.65 μm or 2.0 μm. As a result, the conditions of convergence calculation differ between a case of using a light source of a central wavelength of 1.65 μm and a light source of a central wavelength of 1.45 μm as in embodiment 1, and a case of using a light source of a central wavelength of 2.0 μm and a light source of a central wavelength of 1.45 μm as in this embodiment.

A case where concentration C_{A} (wt. %) and concentration C_{B} (wt. %) in a mixed chemical solution of constituents A and B (such as hydrofluoric acid and nitric acid) contained in the mixed chemical solution to be measured such as an etching solution will now be considered, on the assumption that a binary mixed chemical solution is prepared by mixing single-constituent chemical solutions A and B at a mixing ratio X:Y.

Concentration calculating formulae of single-constituent chemical solutions A and B relative to absorption of the light having a central wavelength of 1.65 μm based on formula (2) are assumed to be represented by straight lines (solid lines) A and B in FIG. 14, respectively. It is also assumed that concentration calculating formulae of the single-constituent chemical solutions A and B relative to absorption of the light having a central wavelength of 2.0 μm are expressed by straight lines (broken lines) A′ and B′ in FIG. 14, respectively.

As described above in embodiment 1, these straight lines can be deemed to represent concentrations C_{A}, C_{B}, C_{A}′ and C_{B}′ of constituents A and B in the mixed chemical solution in the case where the mixed chemical solution comprises only the single-constituent chemical solution A or B.

More specifically, when expressing the straight lines (solid lines) A and B and the straight lines (broken lines) A′ and B′ by:

C_{A}=K_{A}−β_{A} ln(V_{A}) (59)

C_{B}=K_{B}−β_{B} ln(V_{B}) (60)

C_{A}′=K_{A}′−β_{A}′ ln(V_{A}′) (61)

C_{B}′=K_{B}′−β_{B}′ ln(V_{B}′) (62)

where,

V_{A}: PD output relative to the light having a central wavelength of 1.65 μm exhibited when constituent A is a single constituent;

V_{B}: PD output relative to the light having a central wavelength of 1.65 μm exhibited when constituent B is a single constituent;

V_{A}′: PD output relative to the light having a central wavelength of 2.0 μm exhibited when constituent A is a single constituent; and

V_{B}′: PD output relative to the light having a central wavelength of 2.0 μm exhibited when constituent B is a single constituent, the relationship (plot (C, V_{1 65})) between the total concentration C (wt. %) of constituents A and B in the mixed chemical solution and the PD output (V_{1 65}) exhibited when irradiating the light having a central wavelength of 1.65 μm onto the mixed chemical solution is within a range between straight lines (solid lines) A and B, irrespective of at what mixing ratio X:Y the binary mixed chemical solution is formed by mixing single-constituent chemical solutions A and B of what concentrations. Similarly, the relationship (plot (C, V_{2 0})) between concentration C and the PD output (V_{2 0}) exhibited when irradiating the light having a central wavelength of 2.0 μm onto the mixed chemical solution is within a range between straight lines (broken lines) A′ and B′ regarding absorption of the light having a central wavelength of 2.0 μm.

In accordance with such a principle, in this embodiment, the following conditions can be introduced for convergence calculation:

(i) Conditions for convergence calculation:

(ln(V_{A})−ln(V_{1 65})):(ln(V_{1.65})−ln(V_{B}))=Y:X (63)

(ln(V_{B}′)−ln(V_{2 0})):(ln(V_{2 0})−ln(V_{A}′))=Y:X (64)

C_{A}+C_{B}=C_{A}′+C_{B}′(=C=C′) (65)

(ii) Calculation formulae of V_{B}, V_{A}′ and V_{B}′:

Calculation formulae of V_{B}, V_{A}′ and V_{B}′ are derived in the same manner as in embodiment 1.

(iii) Calculation of concentrations:

Initial values V_{B0}, V_{A0}′ and V_{B0}′ of V_{B}, V_{A}′ and V_{B}′ are calculated from the calculation formulae derived in item (ii) by assuming an initial value V_{A0} of V_{A} and an initial value X₀ of X. Then, concentrations C_{A}, C_{B}, C_{A}′ and C_{B}′ are calculated, respectively, from formulae (59) to (62).

(iv) Convergence calculation:

As in embodiment 1, convergence calculation is performed until the following conditions are satisfied:

|(C_{B}−C_{B}′)/C_{B}′|≦0.001

|(X(initial value)−X(calculated value))/X(calculated value)≦0.001

That is, the calculated values of X and V_{A} are calculated in the same manner as in embodiment 1 by means of:

X=ln(V_{1.65}/V_{B})/{ln(V_{A}/V_{1.65})+ln(V_{1 65}/V_{B}} (66)

where, in formula (66), V_{A} and V_{B} are the same as V_{A0} and V_{B0} in item (iii), and:

V_{A}=exp{(K_{A}−C_{A})/β_{A}} (67)

where, in formula (67), C_{A} is calculated from the following formula derived from formula (65):

$$\begin{matrix}{C}_{A} = ( {C}_{A}^{′} + {C}_{B}^{′} ) - {C}_{B} \\ = ( {K}_{A}^{′} + {K}_{B}^{′} - {K}_{B} ) + \{ {β}_{B} ln ( {V}_{B} ) - {β}_{A}^{′} ln ( {V}_{A}^{′} ) - {β}_{B}^{′} ln ( {V}_{B}^{′} ) \}\end{matrix} \qquad ( 68 )$$

where, in formula (68) V_{B}, V_{A}′ and V_{B}′ are the same as V_{B0}, V_{A0}′ and V_{B0}′ in item (iii).

Convergence calculation is accomplished by incorporating V_{A} and X calculated by formulae (66) and (67) back as the initial values of V_{A} and X in item (ii), and repeating the subsequent calculations.

(v) Determination of C_{A} and C_{B}:

C_{A} and C_{B} available upon convergence within a prescribed range as a result of convergence calculation as described above are deemed as concentrations of constituents A and B in the mixed chemical solution.

V_{1.65} and V_{2.0} are PD output values obtained through measurement. Coefficients K_{A}, K_{B}, β_{A} and β_{B} are intrinsic to the individual chemical solutions relative to the light of a central wavelength of 1.65 μm. Coefficients K_{A}′, K_{B}′ and β_{B}′ are intrinsic to the individual chemical solutions relative to the light of a central wavelength of 2.0 μm.

These coefficients K and β are functions of temperature as described above, and are predetermined for the individual chemical solutions, or determined prior to measurement in accordance with a prescribed calibrating procedure described later.

It is therefore possible to detect concentrations C_{A} and C_{B} of constituents A and B in the mixed chemical solution through calculation by the above-mentioned convergence calculation by detecting the chemical solution temperature and the PD output.

As described above, as required, it is of course possible to previously set a K-value and a β-value as constants in the microcomputer 45, and perform calculation by means of these values. In this case, measurement of temperature of the chemical solution flowing through the cell 9 may be omitted.

Further, as described above, in the both cases A and B where the light having a central wavelength of 2.0 μm and the light having a central wavelength of 1.45 μm are used (case A), and where the light having a central wavelength of 1.65 μm and the light having a central wavelength of 2.0 μm (case B), calculation of the concentrations of individual constituents in the binary mixed chemical solution can be accomplished by the same method as the concentration calculating technique 3 described in embodiment 1. Thus, it is possible to calculate concentrations in a higher accuracy. That is, with the constants in the coefficients K, β (formulae (3) and (4)) or K, β itself in the concentration calculating formulae for the light of each wavelength, determined by using a prescribed value or by operating a prescribed calibrating procedure, it is possible to calculate the concentrations of individual constituents in the binary mixed chemical solution in accordance with formulae (110) and (111).

As described above, it is possible to inline measure concentrations of the two constituents to be measured of a mixed chemical solution in a real-time manner at a high accuracy, even when using a laser diode emitting the light of a central wavelength of 2.0 μm as a light source in place of the first light source 4A or the second light source 6A of embodiment 1.

Also in the liquid concentration detecting apparatus of this embodiment, it is possible to achieve concentration detection at a very high accuracy free from temperature variations by providing a temperature control mechanism similar to that described in embodiment 1. The temperature control mechanism has already been explained as to embodiment 1.

Embodiment 3

According to the invention, it is possible to detect concentrations of three constituents of a ternary-constituent mixed chemical solution by irradiating light beams of three different wavelength bands, having a central wavelength within a range of from 1.4 to 2.05 μm onto the solution. In this embodiment, this is achieved by providing three projecting sections having respective light sources. Since the detecting section and the control section of the liquid concentration detecting apparatus of this embodiment have basically the same configurations as those in embodiment 1, parts having the same configuration and functions are assigned the same reference numerals, and omitting a detailed description of the parts. For detailed description of the parts, the description of embodiment 1 is applicable.

When adopting a configuration of irradiating light beams of at least three different wavelength bands by providing a plurality of light sources, as in the case described above, concentrations of the three constituents of a ternary mixed chemical solution can be determined in principle by providing three optical component groups as shown in FIG. 17 each comprising a projecting section 4A, a beam splitter 8, a transmitting light receiving section 11 and a reference light receiving section 13, irradiating light beams from the projecting sections onto the solution flowing in a cell 9, and making an arrangement so as to permit measurement of the amount of transmitting light. For example, this is achievable by using a configuration in which a detecting section 94 of the cell 9 is extended in the flowing direction of the solution, and piling up the three sets of optical components in the flowing direction of the solution as shown in FIG. 17.

In this embodiment, the two projecting sections have the arrangement configurations as described for embodiments 1 and 2, and in addition, another set of optical components is provided so as to permit simplification of the configuration.

More specifically, a configuration permitting measurement of the amount of light having passed through the solution is achieved by extending the detecting section of the cell 9 (FIG. 3) in the flowing direction of the solution, piling up an optical component group shown in FIG. 1, comprising a first projecting section 4, a second projecting section 6, a first beam splitter 8, a first transmitting light receiving section 11 and a first reference light receiving section 13, and another optical component group shown in FIG. 17 comprising a third projecting section 101, a second beam splitter 103, a second transmitting light receiving section 105 and a second reference light receiving section 107, and irradiating light from each projecting section onto the solution and making an arrangement so as to permit measurement of the amount of transmitting light. As in the above-mentioned embodiments, a collimator lens 102 is provided in the third projecting section 101, and condenser lenses 106 are provided in the second transmitting light receiving section 105 and the second reference light receiving section 107. Photodiodes used in the above-mentioned embodiments are used as the second transmitting light receiving section 105 and the second reference light receiving section 107.

In this embodiment, the laser diode emitting light having a central wavelength of 1.65±0.05 μm (made by NTT Electronics Co.: Model NKL1601CCA/TOA) (the light source having a central wavelength of 1.65 μm) is used as the first light source 4A of the first projecting section 4. The laser diode emitting light having a central wavelength of 2.0±0.05 μm (made by NTT Electronics Co.: Model KELD1901CCA/TOA) (the light source having a central wavelength of 2.0 μm) is used as the second light source 6A of the second projecting section. The laser diode emitting light having a central wavelength of 1.45±0.015 μm (made by NTT Electronics Co.: Model NKL1402TOB) (the light source having a central wavelength of 1.45 μm) is used as the third light source of the third projecting section 101.

As described above, absorption of light near a wavelength of 1.45 μm is based on an absorbing wavelength band attributable to oxygen-hydrogen binding group of water (overtone of O—H stretching vibration). The difference in absorption of light near a wavelength region of from 1.55 to 1.9 μm is based on ionic hydration in the aqueous solution. The difference in absorption of light near a wavelength region of from 1.9 to 2.0 μm is based on a sum (synthesis) of light absorption attributed to oxygen-hydrogen binding group of water (synthesis of overtone of O—H stretching vibration and overtone of O—H bending vibration) and light absorption caused by ionic hydration. The first, second and third light sources have thus different causes of light absorption. It is therefore possible to suitably detect concentrations of three constituents in the chemical solution through the following calculation by irradiating light beams of three wavelength bands different in degree of change in absorbance caused by the difference in concentration of chemical solution.

According to this embodiment, the PD output corresponding to the light from the second light source 6A is derived in accordance with formula (5), as described in embodiment 1.

Calculation of concentrations of individual constituents in a ternary mixed chemical solution can be accomplished by, for example, the same method as the concentration calculating technique 1 described in embodiment 1. This is an approximate calculating method applicable in response to a required measuring accuracy, constituents of the chemical solution to be measured and the like.

When determining concentrations C_{A} (wt. %), C_{B} (wt. %) and C_{C} (wt. %)in a mixed chemical solution of constituents A, B and C (such as hydrofluoric acid—nitric acid—acetic acid) contained in the chemical solution to be measured such as etching solutions, if additivity is assumed to be valid for concentrations of constituents A, B and C, concentration C of the mixed chemical solution would be, as in embodiments 1 and 2, as follows:

C=C_{A}+C_{B}+C_{C} (69)

(i) Absorption of the light having a central wavelength of 1.65 μm by a ternary mixed chemical solution will be considered on the following assumption. If it is assumed that a mixed chemical solution is obtained by mixing single-constituent chemical solutions A, B and C having concentrations C_{A(single 1.65)}, C_{B(single 1.65)} and C_{C(single 1.65)}, respectively, at mixing ratios X (wt/wt. %), Y (wt/wt. %) and Z (wt/wt. %), then:

C_{A}=C_{A(single 1.65)}·X/100 (70)

C_{B}=C_{B(single 1.65)}·Y/100 (71)

C_{C}=C_{C(single 1.65)}·Z/100 (72)

X+Y+Z=100 (73)

are valid, and from formula (69):

$${C}_{A ( single 1 \; 65 )} \cdot X / 100 + {C}_{B ( single 1.65 )} \cdot Y / 100 + {C}_{C ( single 1 \; 65 )} \cdot Z / 100 = {C}_{A} + {C}_{B} + {C}_{C} \qquad ( 74 )$$

is obtained.

As described above, since formula (2) is valid for all the constituents to be measured in a chemical solution, concentrations C_{A(single 1 65)}, C_{B(single 1 65)} and C_{C(single 1.65)} of single constituent chemical solutions A, B and C relative to the light having a central wavelength of 1.65 μm are represented by:

C_{A(single 1 65)}=K_{AI}−β_{AI} ln(V_{AI}) (75)

C_{B(single 1 65)}=K_{BI}−β_{BI} ln(V_{BI}) (76)

C_{C(single 1.65)}=K_{CI}−β_{CI} ln(V_{CI}) (77)

where,

V_{AI}: PD output relative to the light having a central wavelength of 1.65 μm exhibited when constituent A is a single constituent;

V_{BI}: PD output relative to the light having a central wavelength of 1.65 μm exhibited when constituent B is a single constituent; and

V_{CI}: PD output relative to the light having a central wavelength of 1.65 μm exhibited when constituent C is a single constituent.

If the following relationship is assumed to be approximately valid:

V_{AI}=V_{BI}=V_{CI}=V_{1.65}

where,

V_{1.65}: PD output relative to the light having a wavelength of 1.65 μm exhibited by the mixed solution,

then, formula (74) may be rewritten, from the relationship shown by formulae (75), (76) and (77), as follows:

$$( {K}_{AI} - {β}_{AI} ln ( {V}_{1 \; 65} ) ) X + ( {K}_{BI} - {β}_{BI} ln ( {V}_{1.65} ) ) Y + ( {K}_{CI} - {β}_{CI} ln ( {V}_{1.65} ) ) Z = 100 ( {C}_{A} + {C}_{B} + {C}_{C} ) \qquad ( 78 )$$

(ii) On the other hand, a similar concept is introduced regarding absorption of the light having a central wavelength of 2.0 μm by a ternary mixed chemical solution. More specifically, if a mixed chemical solution is assumed to be obtained by mixing single-constituent chemical solutions A, B and C having concentrations C_{A(single 2.0)}, C_{B(single 2.0)} and C_{C(single 2 0)}, respectively, at mixing ratios X (wt/wt. %), Y (wt/wt. %) and Z (wt/wt. %), respectively:

C_{A}=C_{A(single 2.0)}·X/100 (79)

C_{B}=C_{B(single 2 0)}·Y/100 (80)

C_{C}=C_{C(single 2 0)}·Z/100 (81)

X+Y+Z=100 (82)

would be valid, and from formula (69):

$${C}_{A ( single 2.0 )} \cdot X / 100 + {C}_{B ( single 2.0 )} \cdot Y / 100 + {C}_{C ( single 2.0 )} \cdot Z / 100 = {C}_{A} + {C}_{B} + {C}_{C} \qquad ( 83 )$$

is obtained.

Since formula (2) is valid for all the constituents to be measured in the chemical solution, as described above, concentrations C_{A(single 2 0)}, C_{B(single 2 0)} and C_{C(single 2.0)} of single-constituents A, B and C relative to the light of a wavelength of 2.0 μm are represented, respectively, by:

C_{A(single 2 0)}=K_{AII}−β_{AII} ln(V_{AII}) (84)

C_{B(single 2.0)}=K_{BII}−β_{BII} ln(V_{BII}) (85)

C_{C(single 2.0)}=K_{CII}−β_{CII} ln(V_{CII}) (86)

where,

V_{AII}: PD output relative to the light having a central wavelength of 2.0 μm exhibited when constituent A is a single constituent;

V_{BII}: PD output relative to the light having a central wavelength of 2.0 μm exhibited when constituent B is a single constituent; and

V_{CII}: PD output relative to the light having a central wavelength of 2.0 μm exhibited when constituent C is a single constituent.

If the following relationship is assumed to be valid approximately:

V_{AII}=V_{BII}=V_{CII}=V_{2.0}

where,

V_{2.0}: PD output exhibited by the mixed solution relative to the light of a wavelength of 2.0 μm,

then, formula (83) would be rewritten, from formulae (84), (85) and (86), as follows:

$$( {K}_{AII} - {β}_{AII} ln ( {V}_{2.0} ) ) X + ( {K}_{BII} - {β}_{BII} ln ( {V}_{2.0} ) ) Y + ( {K}_{CII} - {β}_{CII} ln ( {V}_{2.0} ) ) Z = 100 ( {C}_{A} + {C}_{B} + {C}_{C} ) \qquad ( 87 )$$

(iii) Absorption of the light having a central wavelength of 1.45 μm by a ternary mixed chemical solution is approximately considered as follows. As described in embodiment 1, in relation to absorption of the light having a central wavelength of 1.45 μm by a mixed chemical solution, the relationship of formula (2) is assumed to be valid between PD output (V_{1.45}) and the quantity of water itself C_{W} (wt. %). It is also assumed by measuring the water quantity C_{W} (wt. %) in the mixed chemical solution in absorption of the light of a central wavelength of 1.45 μm, that the balance is equal to the total concentration C (wt. %) of constituents A, B and C in the mixed chemical solution.

C_{W}=100−C=K_{W}−β_{W} ln(V_{1.45}) (88)

C=C_{A}+C_{B}+C_{C}=100−K_{W}+β_{W} ln(V_{1.45}) (89)

where,

V_{1.45}: PD output relative to the light having a central wavelength of 1.45 μm exhibited by the mixed chemical solution.

The above-mentioned V_{1.65}, V_{2 0} and V_{1 45} are PD output values obtained through measurement. Coefficients K_{AI}, K_{BI}, K_{CI}, β_{AI}, β_{BI} and β_{CI} are values intrinsic to the individual chemical solutions relative to the light having a central wavelength of 1.65 μm. Coefficients K_{AII}, K_{BII}, K_{CII}, β_{AII}, β_{BII} and β_{CII} are values intrinsic to the individual chemical solutions relative to the light having a central wavelength of 2.0 μm. Coefficients K_{W} and β_{W} are values intrinsic to water quantity relative to the light having a central wavelength of 1.45 μm.

As described in embodiment 1, these coefficients K and β are functions of temperature, and are predetermined for the individual chemical solutions, or determined prior to measurement in accordance with a prescribed calibrating procedure described later.

By detecting the chemical solution temperature and the PD output, as in embodiment 1, therefore, it is possible to derive X, Y and Z from the relationship shown in formulae (78), (87), (89) and (73) (or (82)), and by eliminating X, Y and Z from:

C_{A}=(K_{AI}−β_{AI} ln(V_{1.65}))·X/100

C_{B}=(K_{BI}−β_{BI} ln(V_{1.65}))·Y/100

C_{C}=(K_{CI}−β_{CI} ln(V_{1 65}))·Z/100

or

C_{A}=(K_{AII}−β_{AII} ln(V_{2.0}))·X/100

C_{B}=(K_{BII}−β_{BII} ln(V_{2 0}))·Y/100

C_{C}=(K_{CII}−β_{CII} ln(V_{2.0}))·Z/100

it is possible to calculate C_{A}, C_{B} and C_{C}.

As in embodiments 1 and 2, as required, it is of course possible to previously set K-values and β-values themselves as constants in the microcomputer 45, and perform calculations using these values. In this case, measurement of temperature of the chemical solution flowing through the cell 9 may be omitted.

Further, calculation of the concentrations of individual constituents in the ternary mixed chemical solution can be accomplished by the same method as the concentration calculating technique 3 described in embodiment 1. Thus, it is possible to calculate concentrations in a higher accuracy.

Consideration will now be made about a case where a certain ternary constituent composition is obtained by mixing single-constituent chemical solutions (components). On the basis of the fact that, for the light of a particular wavelength, absorbance for multiple-constituent mixed chemical solution is equivalent to the sum of absorbance for each component, the calculating formulae for calculating the concentrations of each component can be led from absorbance for ternary mixed chemical solution by a reverse operation. Then, assuming that single-constituent chemical solutions A [concentration: ((l+m+n)/l)·C_{A}], B [concentration: ((l+m+n)/m)·C_{B}] and C [concentration: ((l+m+n)/n)·C_{C}] are mixed at mixing ratio l:m:n, with respect to the mixed chemical solution [volume: l+m+n], the formulae of absorbance for the light of each wavelength can be led. Thus, the concentration calculating formulae for individual constituents in the mixed chemical solution can be obtained.

Using the matrix of the formula (12), the following concentration calculating formulae for each constituent are available:

$$\begin{matrix}Δ = ( \begin{matrix}1 / {β}_{A} & 1 / {β}_{B} & 1 / {β}_{C} \\ 1 / {β}_{A}^{′} & 1 / {β}_{B}^{′} & 1 / {β}_{C}^{′} \\ 1 / {β}_{A}^{″} & 1 / {β}_{B}^{″} & 1 / {β}_{C}^{″}\end{matrix} ) & ( 112 ) \\ {C}_{A} = ( 1 / Δ ) \times ( \begin{matrix}F & 1 / {β}_{B} & 1 / {β}_{C} \\ {F}^{′} & 1 / {β}_{B}^{′} & 1 / {β}_{C}^{′} \\ {F}^{″} & 1 / {β}_{B}^{″} & 1 / {β}_{C}^{″}\end{matrix} ) & ( 113 ) \\ {C}_{B} = ( 1 / Δ ) \times ( \begin{matrix}1 / {β}_{A} & F & 1 / {β}_{C} \\ 1 / {β}_{A}^{′} & {F}^{′} & 1 / {β}_{C}^{′} \\ 1 / {β}_{A}^{″} & {F}^{″} & 1 / {β}_{C}^{″}\end{matrix} ) & ( 114 ) \\ {C}_{C} = ( 1 / Δ ) \times ( \begin{matrix}1 / {β}_{A} & 1 / {β}_{B} & F \\ 1 / {β}_{A}^{′} & 1 / {β}_{B}^{′} & {F}^{′} \\ 1 / {β}_{A}^{″} & 1 / {β}_{B}^{″} & {F}^{″}\end{matrix} ) \\ \text{where,} \\ F = θ - Ln ( τ ) \\ {F}^{′} = ϵ - Ln ( {τ}^{′} ) \\ {F}^{″} = δ - Ln ( {τ}^{″} ) \\ \text{and,} \\ θ = {K}_{A} / {β}_{A} = {K}_{B} / {β}_{B} = {K}_{C} / {β}_{C} \\ ϵ = {K}_{A}^{′} / {β}_{A}^{′} = {K}_{B}^{′} / {β}_{B}^{′} = {K}_{C}^{′} / {β}_{C}^{′} \\ δ = {K}_{A}^{″} / {β}_{A}^{″} = {K}_{B}^{″} / {β}_{B}^{″} = {K}_{C}^{″} / {β}_{C}^{″} & ( 115 )\end{matrix}$$

(Description of character)

C_{A}: concentration of constituent A contained in the ternary chemical solution

C_{B}: concentration of constituent B contained in the ternary chemical solution

C_{C}: concentration of constituent C contained in the ternary chemical solution

τ: transmission coefficient (or output of light receiving system) of the first light (wavelength: 1.65 μm) for the ternary chemical solution

τ′: transmission coefficient (or output of light receiving system) of the second light (wavelength: 1.45 μm) for the ternary chemical solution

τ″: transmission coefficient (or output of light receiving system) of the third light (wavelength: 2.0 μm) for the ternary chemical solution

τ_{A}: transmission coefficient (or output of light receiving system) of the first light for the single-constituent chemical solution A [concentration: ((l+m+n)/l)·C_{A}]

τ_{B}: transmission coefficient (or output of light receiving system) of the first light for the single-constituent chemical solution B [concentration: ((l+m+n)/m)·C_{B}]

τ_{C}: transmission coefficient (or output of light receiving system) of the first light for the single-constituent chemical solution C [concentration: ((l+m+n)/n)·C_{C}]

τ_{A}′: transmission coefficient (or output of light receiving system) of the second light for the single-constituent chemical solution A [concentration: ((l+m+n)/l)·C_{A}]

τ_{B}′: transmission coefficient (or output of light receiving system) of the second light for the single-constituent chemical solution B [concentration: ((l+m+n)/m)·C_{B}]

τ_{C}′: transmission coefficient (or output of light receiving system) of the second light for the single-constituent chemical solution C [concentration: ((l+m+n)/n)·C_{C}]

τ_{A}″: transmission coefficient (or output of light receiving system)of the third light for the single-constituent chemical solution A [concentration: ((l+m+n)/l)·C_{A}]

τ_{B}″: transmission coefficient (or output of light receiving system) of the third light for the single-constituent chemical solution B [concentration: ((l+m+n)/m)·C_{B}]

τ_{C}′: transmission coefficient (or output of light receiving system) of the third light for the single-constituent chemical solution C [concentration: ((l+m+n)/n)·C_{C}]

K_{A}, K_{B}, K_{C}, K_{A}′, K_{B}′, K_{C}′, K_{A}″, K_{B}″, K_{C}″, β_{A}, β_{B}, β_{C}, β_{A}′, β_{B}′, β_{C}′, β_{A}″, β_{B}″ and β_{C}″

:constants of concentration calculating formula (formula (2)) of single-constituent chemical solutions A, B and C for the light of each wavelength

As in the case of binary mixed chemical solution in embodiment 1, with the constants in the coefficients K, β (formulae (3) and (4)) or K, β itself in the concentration calculating formulae for the light of each wavelength, determined by using a prescribed value or by operating a prescribed calibrating procedure, it is possible to calculate the concentrations of individual constituents in the ternary mixed chemical solution in accordance with formulae (113), (114) and (115).

Concentrations of constituents can be detected of a ternary chemical solution, for example, HF—HNO₃—CH₃COOH, or H₃PO₄—HNO₃—CH₃COOH aqueous solution used as an etching solution or a cleaning solution.

In the liquid concentration detecting apparatus of this embodiment as well, it is possible to accomplish very high-accuracy concentration detection free from change in temperature by providing a temperature control mechanism similar to that described in embodiment 1. The temperature control mechanism of the invention is applicable to a detecting section having an optical system having only one projecting section, as described later. The one described in embodiment 1 may be used as a temperature control mechanism of an optical system parts including first and second projecting sections, and it suffices to use a configuration providing a temperature control mechanism of optical system parts including a third light source. For details about the temperature control mechanism, refer to the description in embodiments.

According to the present invention, as described above, it is possible to inline detect in a real-time manner the concentrations at a high accuracy of constituents to be measured of a ternary mixed chemical solution.

Embodiment 4

In the above-mentioned embodiments 1 to 3, a plurality of projecting sections having respective light sources irradiating light beams of different wavelength bands are provided, so as to irradiate light beams of at least two wavelength bands with a central wavelength within a range of from 1.4 to 2.05 μm onto the solution. The present invention is not however limited to this configuration.

More specifically, in an optical system comprising a projecting section 4, a beam splitter 8, a transmitting light receiving section 11 and a reference light receiving section 13 as described in FIG. 17, a variable wavelength type (wavelength-tunable type) light source such as a variable wavelength type laser as a light source 4A may be used to emit the light beams of different wavelength bands from one projecting section.

In this case also, concentrations of individual constituents contained in a multiple-component chemical solution can be detected, through sequential detection of the amount of light passing through the solution by irradiating while switching over light beams of at least two different wavelength bands each having a central wavelength within a range of from 1.4 to 2.05 μm, or preferably, light beams of at least two different wavelength bands each having a central wavelength within a range of from 1.42 to 1.48 μm, from 1.55 to 1.85 μm, or from 1.95 to 2.05 μm onto the solution in the cell 9 from the variable wavelength type light source, and by calculating in accordance with the calculating method described above.

It is needless to mention that it is possible to adopt a configuration in which two projecting sections are provided in the layout configuration described in embodiment 1, and beams of two different wavelength bands by providing a variable wavelength type light source in one of the projecting sections to permit irradiation light of three different wavelength bands in total.

The liquid concentration detecting apparatus of this embodiment can basically have the same configuration in the detecting section and the control section as that of the liquid concentration detecting apparatus of embodiment 1, except that a projecting section 4 having a variable wavelength type light source is used. Because the same calculating method as in embodiments 1 to 3 is applicable, description of the method is omitted here by referring to the corresponding description in the above embodiments.

In this embodiment also, it is possible to achieve detection of concentration of a very high accuracy free from temperature variation by providing the same temperature control mechanism as that described in embodiment 1. For the detail of the temperature control, reference is made to the description thereof in embodiment 1.

According to the present invention, as described above, it is possible to carry out inline real-time detection at a high accuracy of the concentrations of a plurality of constituents contained in a chemical solution to be measured by using a variable wavelength type light source.

Embodiment 5

Still another embodiment of the liquid concentration detecting apparatus of the invention will now be described.

The arrangement configuration of projecting sections described in embodiment 1 has also the functional effect as described below.

In the liquid concentration detecting apparatus described in embodiment 1, by using a first light source 4A and a second light source 6A emitting light beams of the same wavelength band, when detecting the concentration of a single-constituent chemical solution, and if the single light source is not sufficient to give a necessary amount of light, or when it is necessary to ensure an amount of light sufficient to provide a longer optical path for the light passing through the sample, it is possible to suitably increase the amount of light of a desired wavelength. In this case, it is not necessary to use light cutoff means 15 for cutting off the light from the second light source 6A at a prescribed timing.

By adopting a configuration in which the light beams from the first projecting section 4 and the second projecting section 6 cross each other at right angles in the beam splitter 8 according to the present invention, it is possible to increase the amount of light of a prescribed wavelength band through common use of the optical components other than the light sources (the beam splitter 8, the transmitting light receiving section 11, the reference light receiving section 13 and the PD amplifying circuit board 14) by the both light sources. Thus, it is possible to simplify the configuration, and considerably reduce the cost. The number of parts to be subjected to temperature control can be reduced, and this provides another advantage of facilitating temperature control of the optical system components (including the PD amplifying circuit board 14).

By using, in the configuration described in embodiment 3, first and second light sources 4A and 6A emitting light beams of the same wavelength band, and a third light source emitting a light beam of a wavelength band different from that of the first and second light sources 4A and 6A, it is possible to increase the amount of light of a prescribed wavelength band from the first and second light sources 4A and 6A, and in addition, to detect the concentrations of the constituents of a binary mixed chemical solution.

Embodiment 6

In embodiment 1, a novel temperature control mechanism permitting measurement of the liquid concentration at a high accuracy was described in detail. The principle of this temperature control mechanism of optical components is not limited to application to a liquid concentration detecting apparatus 1 having two projecting sections as in the liquid concentration detecting apparatus 1 of embodiment 1.

For example, as shown in FIG. 17, the aforementioned principle is applicable also to a liquid concentration detecting apparatus having a cell 9 to which the solution is fed, a projecting section 4 and a transmitting light receiving section 11 facing each other in a direction perpendicular to the axial line of the solution flow path in the cell 9, and a beam splitter 8 which takes out a part of the light from the projecting section 4 and directs the light toward the reference light receiving section 13, i.e., a liquid concentration detecting apparatus of a single-component chemical solution, or a liquid concentration detecting apparatus which detects concentrations of at least two constituents contained in the aqueous solution by use of a projecting section having a variable wavelength laser and the like as described above.

As described above, by conducting temperature control of the projecting section 4, the beam splitter 8, the transmitting light receiving section 11, the reference light receiving section 13, and the amplifying circuit board of the light detectors of the light receiving sections 11 and 13, it is possible to detect concentration at a very high accuracy.

Because all the configurations except for the second projecting section in embodiment 1 are applicable to the liquid concentration detecting apparatus of this embodiment, description of portions in duplicate is omitted here, and the corresponding description in embodiment 1 is applied.

Embodiment 7

In this embodiment, a calibrating (correcting) procedure of a liquid concentration calculating formulae applicable to the liquid concentration detecting apparatus according to the present invention will be described.

In the liquid concentration detecting method according to the invention, as described above, in order to calculate the concentrations of the constituents to be measured contained in a sample solution, coefficients K and β contained in these calculating formulae must be determined in advance.

Coefficients K and β for each constituent to be measured can of course be previously stored in a microcomputer 45 of the control section 40 as predetermined values. When achieving detection of concentration at a higher accuracy in response to each liquid concentration detecting apparatus or measuring environment, however, it is desirable to carry out calibration prior to starting measurement, i.e., at the point in time of installation of the apparatus at an actual site where the liquid concentration detecting apparatus is used.

An embodiment of the site calibrating procedures according to the invention include:

(1) A standard calibration of determining new formulae for coefficients K and β by circulating calibrating chemical solutions on two levels of concentration and two levels of temperature for each concentration, relative to each constituent to be measured and each wavelength band of light, to the apparatus, and incorporating the PD output in the microcomputer 45; and

(2) A simplified calibration procedure of circulating a calibrating chemical solutions on one level of concentration and two levels of temperature relative to each constituent to be measured and each wavelength band of light to the apparatus, determining a new formula for coefficient K by incorporating PD output into the microcomputer 45, and using a predetermined value for a formula for coefficient β.

When determining a concentration at a higher accuracy, it is desirable to make a calibration of the calculating formulae with reference to the standard calibration prior to measurement.

The principle of the standard calibration will now be described. By applying set concentrations (C₁ and C₂) and set temperatures (t₁, t₂, t₃ and t₄) for each constituent to be measured to formulae (2), (3) and (4), the following group of formulae is available:

C₁=at₁+b−(mt₁+n)ln(V₁) (90)

C₁=at₂+b−(mt₂+n)ln(V₂) (91)

C₂=at₃+b−(mt₃+n)ln(V₃) (92)

C₂=at₄+b−(mt₄+n)ln(V₄) (93)

where, V₁ to V₄: Values of PD output for the light of a particular wavelength band (for example, the light having a central wavelength of 1.65 μm).

Constants a, b, m and n intrinsic to constituents to be measured for a particular wavelength are calculated anew by means of formulae (90) to (93), thereby determining a coefficient K-formula (formula (3)) and a coefficient β-formula (formula (4)).

More specifically, this determination comprises the steps of circulating a solution having a first concentration measured separately as a calibrating chemical solution to a flow cell of the liquid concentration detecting apparatus, adjusting the solution temperature to a prescribed first temperature, irradiating light from a light source onto the solution, and stores a PD output thereof at a point in time when the solution temperature and the PD output are stabilized. Then, the solution temperature is adjusted to a second temperature, and a PD output is similarly stored when the solution temperature and the PD output are stabilized.

After storing values of PD output on two levels of temperature for the first concentration, values of PD output on two levels of temperature are similarly stored for the second concentration.

For concentration detection of a single-component chemical solution, the aforementioned procedure is carried out for a PD output relative to the light of a wavelength band. For concentration detection of a multiple-constituent chemical solution, the same steps are repeated for values of PD output for a plurality of wavelength bands.

As a result, there is available a group of formulae derived from application of detected values of PD output and set values of concentration and temperature to formulae (90) to (93), for the PD output relative to the light of each constituent to be measured and each wavelength band. Since these formulae give a sufficient number of formulae as to unknown numbers to be calculated for light of each constituent to be measured and each wavelength, it is possible to determine constants for formulae (3) and (4) intrinsic to each constituent to be measured for light of each wavelength band by performing, for example, well known matrix calculations.

Preferably, all values of PD output incorporated into the microcomputer 45 in the calibrating procedure should be values corrected by multiplying the ratio (transmitting light PD output/reference light PD output) by a predetermined reference value Q (for example, a reference light PD output at 25° C.) in accordance with formula (1).

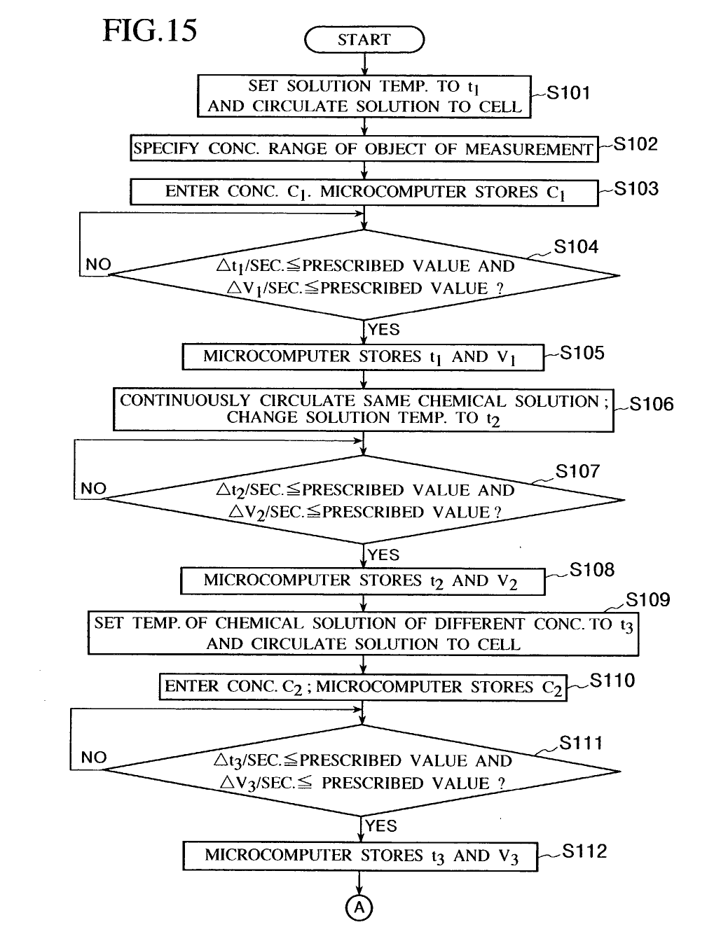

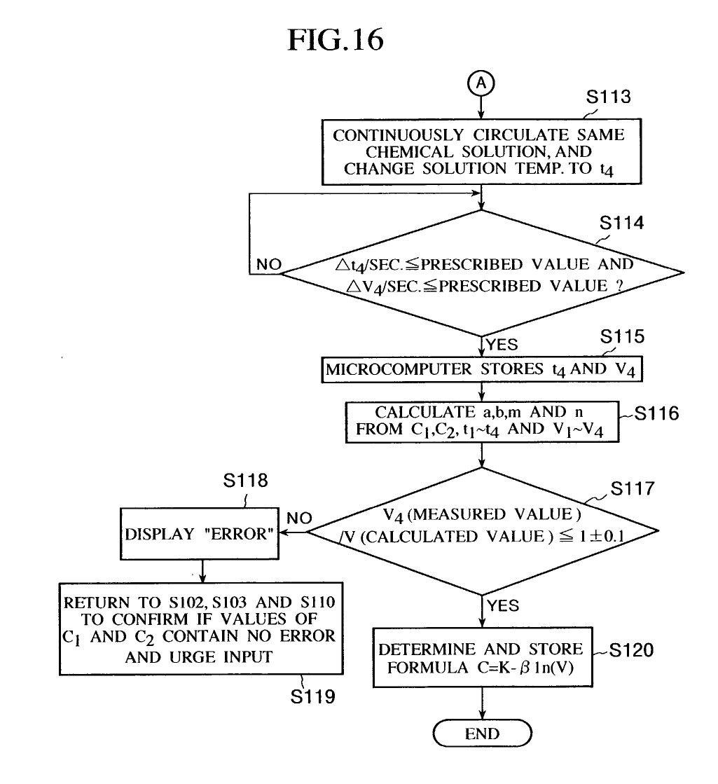

An embodiment of the calibrating procedure of the concentration calculating formulae according to the present invention will now be described with reference to the flowcharts of FIGS. 15 and 16. For a case of concentration detection of a single-component chemical solution by use of the first light source 4A (central wavelength: 1.65 μm) of the liquid concentration detecting apparatus 1 described in embodiment 1, the calibrating procedure will be described. In this example, the description is based on the liquid concentration detecting apparatus connected to a cleaning apparatus in a semiconductor manufacturing process.

S101: Setting temperature of a chemical solution of the cleaning apparatus to t₁ (° C.) (t₁≦40° C.) within a range of the control temperature of the cleaning apparatus control temperature, and circulating the solution to the cell 9 of the liquid concentration detecting apparatus 1.

S102: Specifying a range of concentration of the solution to be measured by means of an operating panel (not shown) provided in the liquid concentration detecting apparatus 1. The microcomputer 45 should be set to display three columns to two columns below decimal point of concentration display on a display section 47 for a specified concentration range of from 0 to 1 wt. % (low-concentration solution) (accuracy: ±0.01 wt. %); three columns to two columns below decimal point of concentration display for a concentration range of from 1 to 10 wt. % (medium-concentration solution) (accuracy: ±0.05 wt. %); and three columns to one column below decimal point for concentration of at least 10 wt. % (high-concentration solution) (accuracy: ±10.1 wt. %).

S103: Entering concentration C₁ (wt. %) of the circulated solution as separately analyzed in accordance with JIS K 8001 from the operating panel. The microcomputer 45 incorporates the entered value of C₁ and stores it. Pure water (concentration of the chemical solution: 0 wt. %) may be used as a circulated solution of concentration C₁, and in this case, it is not necessary to carry out a separate analysis of concentration.

S104: The microcomputer 45 counts the amounts of change per unit time Δt₁/second and ΔV₁/second for temperature t₁ (° C.) and PD output V₁ (mV), determines whether or not these amounts have become under predetermined values, and continues to monitor the chemical solution temperature and PD output while these amounts are over prescribed values.

S105: When the amounts of change Δt₁/second and ΔV₁/second are determined to be under the prescribed values in S104, and the chemical solution temperature and PD output are determined to be stabilized, the microcomputer 45 incorporates t₁ and V₁, sets them as calculation data, and stores them.

S106: Continuously circulating the same chemical solution as in S101 to S105 to the cell 9, and changing the solution temperature to t₂ (t₂≦40° C.). The value of t₂ should be a temperature within a control temperature range of the cleaning apparatus, or a temperature close to this level, and |t₁t₂|≧5° C. should preferably be satisfied to improve the calibration accuracy.

S107: The microcomputer 45 counts the amounts of change per unit time Δt₂/second and ΔV₂/second for temperature t₂ (° C.) and PD output V₂ (mV), determines whether or not these amounts have become under predetermined values, and continues to monitor the chemical solution temperature and PD output while these amounts are over the prescribed values.

S108: When the amounts of change Δt₂/second and ΔV₂/second are determined to be under the prescribed values in S107, and the chemical solution temperature and PD output are determined to be stabilized, the microcomputer 45 incorporates t₂ and V₂, sets them as calculation data, and stores them.

S109: Setting a chemical solution having a different concentration from that circulated to the cell 9 in S101 to S108 to t₃ (° C.) (t₃≦40° C.) within an apparatus control temperature range, and circulate it to the cell 9. Preferably, t₃=t or t₃≈t₁.

S110: Entering a concentration C₂ (wt. %) of the circulated solution as analyzed separately in accordance with JIS K 8001 from the operating panel. The microcomputer 45 incorporates the entered value of C₂ and stores it.

S111: The microcomputer 45 counts the amounts of change per unit time Δt₃/second and ΔV₃/second for temperature t₃ (° C.) and PD output V₃ (mV), determines whether or not these amounts have become under predetermined values, and continues to monitor the chemical solution temperature and PD output while these amounts are over the prescribed values.

S112: When the amounts of change Δt₃/second and ΔV₃/second are determined to be under the prescribed values in S111, and the chemical solution temperature and PD output are determined to be satisfied, the microcomputer 45 incorporates t₃ and V₃, sets them as calculation data, and stores them.

S113: Continuously circulating the same chemical solution as in S109 to S112 to the cell 9, and changing the solution temperature to t₄ (t₄≦40° C.). The value of t₄ should be a temperature within a control temperature range of the cleaning apparatus, or a temperature close to this level, and |t₃−t₄|≧5° C. should preferably be satisfied to improve the calibration accuracy. Preferably, t₄=t₂ or t₄≈t₂.

S 114: The microcomputer 45 counts the amounts of change per unit time Δt₄/second and ΔV₄/second for temperature t₄ (° C.) and PD output V₄ (mV), determines whether or not these amounts have become under predetermined values, and continues to monitor the chemical solution temperature and PD output while these amounts are over the prescribed values.

S115: When the amounts of change Δt₄/second and ΔV₄/second are determined to be under the prescribed values in S114, and the chemical solution temperature and PD output are determined to be satisfied, the microcomputer 45 incorporates t₄ and V₄, sets them as calculation data, and stores them.

S116: Values a, b, m and n intrinsic to constituents to be measured for light of a central wavelength of 1.65 μm are calculated in accordance with the calculation data C₁, C₂, t₁, t₂, t₃, t₄, V₁, V₂, V₃ and V₄ stored in the microcomputer 45 in the above-mentioned steps, and formulae (90) to (93). For calculation to determine the constants a, b, m and n, calculation formulae of the constants a, b, m and n derived from formulae (90) to (93) are previously stored and C₁, C₂, t₁ to t₄ and V₁ to V₄ stored as calculating data are applied to these calculation formulae, thereby calculating the constants. Or, a, b, m and n can be calculated, as a person skilled in the art knows well, by applying C₁, C₂, t₁ to t₄ and V₁ to V₄ stored as calculating data to the following group of formulae derived from formulae (90) to (93):

at₁+b−ln(V₁)t₁m−ln(V₁)n=C₁ (94)

at₂+b−ln(V₂)t₂m−ln(V₂)n=C₁ (95)

at₃+b−ln(V₃)t₃m−ln(V₃)n=C₂ (96)

at₄+b−ln(V₄)t₄m−ln(V₄)n=C₂ (97)

and by performing matrix calculations for coefficients and constants.

S117: In the following formulae (2), (3) and (4):

C=K−β ln(V) (2)

K=at+b (3)

β=mt+n (4),

C=C₂ and t=t₄ are incorporated, and predetermined standard values of a, b, m and n are applied. The thus backward calculated value of PD output V (mV) is compared with the value Of V₄ measured in S115 among the calibrating procedure to determine whether or not V₄ (measured value)/V (calculated value) is within 1±0.1.

S118: When V₄ (measured value)/V (calculated) is determined not within 1±0.1, for example, “ERROR” is displayed on the display section 47 to notify that calibration has inappropriately been conducted.

S119: When “ERROR” is displayed in S118, the user is urged to perform re-setting of the concentration range, re-input of concentration, re-try of separate concentration measurement, or redoing of the calibrating procedure, so as to determine new concentration formulae.

S120: When V₄ (measured value)/V (calculated value) is determined to be within 1±0.1 in S117, a concentration formula (formula (2)) is determined from the new coefficient K-formula (formula (3)) and the β formula (formula (4)), and stored.

It is thus possible to make a calibration of the concentration calculating formula of an arbitrary constituent contained in the solution to be measured prior to measurement. In the above-mentioned calibrating procedure, manual input of t₁ to t₄ and V₁ to V₄ may be permitted so as to simplify the calibrating procedure. By using a first concentration (C₁) of 0 wt. % (pure water) of the calibrating chemical solution, the step of separately analyzing the concentration can be omitted. Furthermore, the step of separate measurement can be omitted by using a calibrating chemical solution prepared to a prescribed concentration provided by the manufacturer of the apparatus.

The calibration procedure for detecting the concentrations of individual constituents in a multiple-constituent chemical solution will now be described.

When detecting the concentrations of constituents A and B contained in a binary mixed chemical solution by use of a first light source 4A (central wavelength: 1.65 μm) and a second light source (central wavelength: 1.45 μm) in the liquid concentration detecting apparatus 1 of embodiment 1, the process of calibration is as follows. With respect to the first light source 4A (central wavelength: 1.65 μm), firstly, values of PD output on two levels of set concentration and two levels of set temperature each for constituents A and B in accordance with the calibrating procedure described above are obtained by using of calibrating solutions respectively containing constituents as single constituents. Then, respective concentration calculating formulae for constituents A and B relative to the light having a central wavelength of 1.65 μm are determined by determining respective K-formula and P-formula intrinsic to constituents A and B.

With respect to the second light source 6A (central wavelength: 1.45 μm), the calibrating procedure may be performed as described below according to the concentration calculating techniques.

In the case where the concentration calculating technique 1 as described in embodiment 1 is applied, formulae for K and β intrinsic to the amount of water may be determined by storing a value of PD output on two levels of the amount of water and two levels of temperature. Thus, a calculating formula of the amount of water (formula (7)) is determined.

The concentration calculating formula of water (formula (7)) is expressed as a calculating formula of the amount of water (concentration in wt. %) of the aqueous solution to be measured except for the chemical solution constituents. In the liquid concentration detecting apparatus 1 of embodiment 1, the PD output for the light beams from the first light source 4A and the second light source 6A can be derived by chopping applied by light cutoff means 15 at a prescribed timing. Determination of values of PD output for the light of a central wavelength of 1.45 μm on two levels of the amount of water and two levels of temperature can therefore be carried out simultaneously with the step of detecting and storing values of PD output for the light of a central wavelength of 1.65 μm on two levels of concentration and two levels of temperature of constituent A or constituent B.

When applying the concentration calculating technique 2 described in embodiment 1, on the other hand, K-formulae and β-formulae intrinsic to constituents A and B relative to the light of a central wavelength of 1.45 μm by obtaining PD outputs at two points for concentration and two points for temperature for each of constituents A and B, also as to the second light source 6A (central wavelength: 1.45 μm). Concentration calculating formulae of constituents A and B relative to the light of a central wavelength of 1.45 μm are thus determined. In the liquid concentration detecting apparatus of embodiment 1, PD outputs for the light from the first light source 4A and the second light source 6A can be extracted through chopping at a prescribed timing by light cutoff means 15. Therefore, detection of PD outputs for two points of concentration of constituents A and B and for two points for temperature relative to the light of a central wavelength of 1.45 μm can be carried out simultaneously with the step of detecting and storing PD outputs relative to the light of a central wavelength of 1.65 μm for two points of concentration of constituents A and B and two points of temperature.

When, in the liquid concentration detecting apparatus 1 of embodiment 2, detecting concentrations of constituents A and B contained in a binary mixed chemical solution by use of a light source of a central wavelength of 2.0 μm as the first light source 4A, and a light source of a central wavelength of 1.45 μm as the second light source 6A, operation can be carried out in the same manner as in the calibrating procedure for the above-mentioned liquid concentration detecting apparatus 1 of embodiment 1 (both of the cases where the concentration calculating techniques 1 and 2) except that the first light source 4A is a light source of a central wavelength of 2.0 μm.

When conducting detection of concentrations of constituents A and B contained in a binary mixed chemical solution by means of a light source of a central wavelength of 1.65 μm as the first light source 4A and a light source of a central wavelength of 2.0 μm as the second light source 6A, calibration of the concentration calculating formulae can be accomplished in the above-mentioned same procedure as in application of the concentration calculating technique 2 in the liquid concentration detecting apparatus 1 of embodiment 1, except that the second light source is a light source of a central wavelength of 2.0 μm.

When applying the concentration calculating technique 3, regardless of wavelength of the light source used, with respect to the first light source 4A and the second light source 6A, values of PD output on two levels of set concentration and two levels of set temperature each for constituents A and B in accordance with the calibrating procedure described above. Thus, the respective concentration calculating formulae for constituents A and B relative to the light of each wavelength can be determined by determining respective K-formula and β-formula intrinsic to constituents A and B.

By setting concentrations of constituents A and B at 0 wt. % (pure water), it is possible to omit the procedure for separately analyzing concentration. Because temperature and PD output for constituents A and B at the first concentration can be commonly used as a result, the calibrating procedure can be simplified. In calibration of the concentration calculating formulae in concentration detection of a multiple-constituent chemical solution, accuracy confirmation of calibration, i.e., the procedure corresponding to the aforementioned step S117 is carried out for each constituent (and water itself).

Furthermore, as is clear from the above description, also when conducting concentration detection of constituents of a ternary mixed chemical solution by use of a first light source 4A (central wavelength: 1.65 μm), a second light source (central wavelength: 2.0 μm) and a third light source (central wavelength: 1.45 μm) in the liquid concentration detecting apparatus of embodiment 3, the concentration calculating formulae can be corrected in the same manner as in the aforementioned procedure for each light source.

It is clear that, also when using a variable wavelength type light source, it is possible to perform calibration of the concentration calculating formulae of a single-component chemical solution or a multiple-component chemical solution in substantially the same manner as above.

The standard calibrating procedure has been described above. A simplified calibrating procedure will now be described. In the simplified calibration, a PD output for light of each wavelength band is detected by use of a calibrating solution for which one level of concentration and two levels of temperature have been set for each constituent to be measured, thereby determining a new coefficient K. For β formula, a previously set value is employed without making any modification.

More specifically, a solution of which the concentration has separately been measured, serving as a calibrating chemical solution, is circulated to the flow cell of the liquid concentration detecting apparatus, and the solution temperature is adjusted to a first prescribed temperature. Light is irradiated onto this solution from a light source, and at a point in time when the solution temperature and PD output are stabilized, the PD output value is stored. Subsequently, the solution temperature is adjusted to a second temperature, and similarly, the resultant PD output value is stored at a point in time when the solution temperature and the PD output are stabilized.

As a result, there is available a group of formulae in which the detected value of PD output, a set concentration and a set temperature are applied to formulae (90) and (91), relative to PD output for each constituent to be measured and light of each wavelength band. Because known values are used as m and n in these formulae, this group of formulae give a sufficient number of formulae for unknown numbers to be calculated, relative to each constituent to be measured and light of each wavelength band. Thus, K and β formulae intrinsic to each constituent to be calculated for light of each wavelength band can be determined. In the simplified calibrating procedure as well, it is desirable to perform the step of confirming the calibrating accuracy. Also in the simplified calibrating procedure, use of a concentration of 0 wt. % of the calibrating chemical solution eliminates the necessity to carry out a separate concentration analysis. When calibrating the concentration calculating formulae for each constituent of a multiple-component chemical solution, this permits common use of temperatures and PD output values for the individual constituents, thus making it possible to achieve a further simplification of the procedure.

As described above, the liquid concentration detecting apparatus of the present invention permits detection of the solution concentration at a higher accuracy in response to the apparatus used and the use environment of the apparatus, by carrying out calibration of the concentration calculating formulae at the site where the apparatus is used prior to measurement of the concentration.

According to the liquid concentration detecting method and apparatus of the present invention, light beams of at least two different wavelength bands having a central wavelength within a range of from 1.4 to 2.05 μm are irradiated on to a solution, and concentrations of at least two constituents contained in the solution are detected by detecting the amount of light transmitting through the solution relative to the light beams of each wavelength band. It is therefore possible to detect in line in a real-time manner at a high accuracy the concentrations of a plurality of constituents contained in an aqueous solution such as chemical solutions used in a semiconductor manufacturing process, a liquid crystal substrate manufacturing process or the like, including a cleaning solution, an etching solution or a resist stripping solution.

The present invention permits simplification of the configuration, detection of the liquid concentration at a high accuracy, and reduction of cost. Further, according to the invention also, it is possible to prevent a measurement error caused by temperature characteristics of component parts, and detect the concentration at a high accuracy and a high reliability, at a measuring accuracy of ±0.01 wt. % for each constituent for a concentration range of from 0 to 1 wt. % of the constituents to be measured contained in the chemical solution (low-concentration solution); ±0.05 wt. % for a range of from 1 to 10 wt. % (medium-concentration solution); and ±0. 1 wt. % for a range of at least 10 wt. %.

We claim:

1. A liquid concentration detecting method wherein a first light having a central wavelength within a range of from 1.55 to 1.85 μm and a second light having a central wavelength within a range of from 1.42 to 1.48 μm are irradiated onto a solution, and concentrations of two constituents contained in the solution are detected by detecting the amount of light transmitting through the solution relative to the light beams of each wavelength band.

2. A liquid concentration detecting method according to claim 1, wherein a first light having a central wavelength of 1.65±0.05 μm and a second light having a central wavelength of 1.45±0.015 μm are irradiated onto the solution.

3. A liquid concentration detecting method according to claim 1, wherein said solution comprises an etching solution, a cleaning solution, or a resist stripping solution.

4. A liquid concentration detecting method according to claim 1, wherein said solution contains two components selected from the group consisting of HF—H₂O₂, HF—HCl, HF—NH₄F, HF—HNO₃, NH₃—H₂O₂, H₂SO₄—H₂O₂, H₂SO₄—HCl, H₃PO₄—HNO₃, HCl—H₂O₂, KOH—H₂O₂, and HCl—FeCl₃ or three components selected from the group consisting of HF—HNO₃—CH₃COOH, and H₃PO₄—HNO₃—CH₃COOH.

5. A liquid concentration detecting method wherein a first light having a central wavelength within a range of from 1.9 to 2.05 μm and a second light having a central wavelength within a range from 1.42 to 1.48 μm are irradiated onto a solution, and concentrations of two constituents contained in the solution are detected by detecting the amount of light transmitting through the solution relative to the light beams of each wavelength band.

6. A liquid concentration detecting method according to claim 5, wherein a first light having a central wavelength of 2.0±0.05 μm and a second light having a central wavelength of 1.45±0.015 μm are irradiated onto the solution.

7. A liquid concentration detecting method wherein a first light having a central wavelength within a range of from 1.55 to 1.85 μm and a second light having a central wavelength within a range of from 1.9 to 2.05 μm are irradiated onto a solution, and concentrations of two constituents contained in the solution are detected by detecting the amount of light transmitting through the solution relative to the light beams of each wavelength band.

8. A liquid concentration detecting method according to claim 7, wherein a first light having a central wavelength of 1.65±0.05 μm and a second light having a central wavelength of 2.0±0.05 μm are irradiated onto the solution.

9. A liquid concentration detecting method wherein a first light having a central wavelength within a range of from 1.55 to 1.85 μm, a second light having a central wavelength within a range of from 1.9 to 2.05 μm, and a third light having a central wavelength within a range of from 1.42 to 1.48 μm are irradiated onto a solution, and concentrations of three constituents contained in the solution are detected by detecting the amount of light transmitting through the solution relative to the light beams of each wavelength band.

10. A liquid concentration detecting method according to claim 9, wherein a first light having a central wavelength of 1.65±0.05 μm, a second light having a central wavelength of 2.0±0.05 μm, and a third light having a central wavelength of 1.45±0.015 μm are irradiated onto the solution.

11. A liquid concentration detecting apparatus comprising:
a cell supplied with a solution;
a means for irradiating a first light having a central wavelength within a range of from 1.55 to 1.85 μm and a second light having a central wavelength within a range of from 1.42 to 1.48 μm onto a solution in the cell; and
a means for detecting the amount of light transmitted through the solution in said cell relative to the light beams of each wavelength band;
wherein concentrations of two constituents contained in the solution are detected based on the amount of light transmitting through the solution detected.

12. A liquid concentration detecting apparatus according to claim 11, further comprising a means for taking out a part of the light irradiated onto the solution in said cell as a reference light, and correcting the amount of light transmitting through the solution in said cell on the basis of the amount of reference light.

13. A liquid concentration detecting apparatus according to claim 12, comprising:
(a) a projecting section having a variable wavelength type light source capable of emitting light beams of at least two different wavelength bands;
(b) a beam splitter splitting the light emitted from said projecting section into a first direction and a second direction;
(c) a transmitting light receiving section having a light detector receiving the light emitted from said projecting section, directed toward the first direction by said beam splitter, and transmitted through the solution in said cell; and
(d) a reference light receiving section having a reference light detector receiving the light emitted from said projecting section, and directed toward the second direction by said beam splitter.

14. A liquid concentration detecting apparatus according to claim 12, comprising:
(a) first and second projecting sections having respective light sources;
(b) a beam splitter splitting the light emitted from said first and second projecting sections into a first direction and a second direction;
(c) a transmitting light receiving section having a light detector receiving the light emitted from said first and second projecting sections, directed toward the first direction by said beam splitter, and transmitted through the solution in said cell; and
(d) a reference light receiving section having a reference light detector receiving the light emitted from said first and second projecting sections, and directed toward the second direction by said beam splitter.

15. A liquid concentration detecting apparatus according to claim 14, wherein optical axes of the light beams emitted from said first and second projecting sections cross each other at right angles in said beam splitter.

16. A liquid concentration detecting apparatus according to claim 14, further comprising light cutoff means for cutting off the emitted light from at least any one of said first and second projecting sections to said beam splitter, wherein, in a state in which the light sources of said first and second projecting sections are simultaneously turned on, the light from one of the light sources is cut off at a prescribed timing.

17. A liquid concentration detecting apparatus according to claim 16, wherein said light cutoff means has a shutter mechanism.

18. A liquid concentration detecting apparatus according to claim 16, wherein the light cutoff period by said light cutoff means is within a range of from 1 to 10 seconds.

19. A liquid concentration detecting apparatus according to claim 16, wherein the amount of transmission through the solution of the light emitted from any one of said first and second projecting sections is detected by subtracting the amount of transmission through the solution of the light emitted from one of the projecting sections from the total amount of transmission through the solution of the light emitted from both of said first and second projecting sections.

20. A liquid concentration detecting apparatus according to claim 14, wherein the amount of light transmitting through the solution is detected by multiplying the ratio of the output from said light detector to the output of said reference light detector by a prescribed reference value to correct the output of said light detector.

21. A liquid concentration detecting apparatus according to claim 14, wherein said beam splitter is a non-polarization beam splitter.

22. A liquid concentration detecting apparatus according to claim 14, wherein said beam splitter is a cube beam splitter.

23. A liquid concentration detecting apparatus according to claim 14, further comprising a temperature control mechanism for all or part of said projecting section, said beam splitter, said transmitting light receiving section and said reference light receiving section.

24. A liquid concentration detecting apparatus according to claim 23, further comprising a temperature control mechanism for amplifying circuits of the output of said light detector and said reference light detector.

25. A liquid concentration detecting apparatus according to claim 24, wherein the amplifying circuits of the output of said light detector and said reference light detector are formed integrally on the same substrate.

26. A liquid concentration detecting apparatus according to claim 23, wherein said temperature control mechanism has a cooling mechanism based on Peltier device.

27. A liquid concentration detecting apparatus according to claim 26, wherein said temperature control mechanism further has a heat conducting member for transferring heat from an object of temperature control to said Peltier device.

28. A liquid concentration detecting apparatus according to claim 24, wherein said temperature control mechanism has a cooling mechanism based on Peltier device.

29. A liquid concentration detecting apparatus according to claim 28, wherein said temperature control mechanism further has a heat conducting member for transferring heat from an object of temperature control to said Peltier device.

30. A liquid concentration detecting apparatus according to claim 23, wherein at least the temperature control mechanism for said projecting section is independent of the temperature control mechanism for the other objects of temperature control.

31. A liquid concentration detecting apparatus according to claim 24, wherein at least the temperature control mechanism for said projecting section is independent of the temperature control mechanism for the other objects of temperature control.

32. A liquid concentration detecting apparatus according to claim 11, wherein the light sources of the first and second light are a laser diode emitting light having a central wavelength of 1.65±0.05 μm and a laser diode emitting light having a central wavelength of 1.45±0.015 μm, respectively.

33. A liquid concentration detecting apparatus comprising:
a cell supplied with a solution;
a means for irradiating a first light having a central wavelength within a range of from 1.9 to 2.05 μm and a second light having a central wavelength within a range of from 1.42 to 1.48 μm onto a solution in the cell; and
a means for detecting the amount of light transmitted through the solution in said cell relative to the light beams of each wavelength band;
wherein concentrations of two constituents contained in the solution are detected based on the amount of light transmitting through the solution detected.

34. A liquid concentration detecting apparatus according to claim 33, wherein the light sources of the first and second light are a laser diode emitting light having a central wavelength of 2.0±0.05 μm and a laser diode emitting light having a central wavelength of 1.45±0.015 μm, respectively.

35. A liquid concentration detecting apparatus comprising:
a cell supplied with a solution;
a means for irradiating a first light having a central wavelength within a range of from 1.55 to 1.85 μm and a second light having a central wavelength within a range of from 1.9 to 2.05 μm onto a solution in the cell; and
a means for detecting the amount of light transmitted through the solution in said cell relative to the light beams of each wavelength band;
wherein concentrations of two constituents contained in the solution are detected based on the amount of light transmitting through the solution detected.

36. A liquid concentration detecting apparatus according to claim 35, wherein the light sources of the first and second light are a laser diode emitting light having a central wavelength of 1.65±0.05 μm and a laser diode emitting light having a central wavelength of 2.0±0.05 μm, respectively.

37. A liquid concentration detecting apparatus comprising:
a cell supplied with a solution;
a means for irradiating a first light having a central wavelength within a range of from 1.55 to 1.85 μm, a second light having a central wavelength within a range of from 1.9 to 2.05 μm, and a third light having a central wavelength within a range of from 1.42 to 1.48 μm on to a solution in the cell; and
a means for detecting the amount of light transmitted through the solution in said cell relative to the light beams of each wavelength band;
wherein concentrations of three constituents contained in the solution are detected based on the amount of light transmitting through the solution detected.

38. A liquid concentration detecting apparatus according to claim 37, wherein the light sources of the first, second and third light are a laser diode emitting light having a central wavelength of 1.65±0.05 μm, a laser diode emitting light having a central wavelength 2.0±0.05 μm and a laser diode emitting light having a central wavelength of 1.45±0.015 μm, respectively.
